(19) United States
(12) Patent Application Publication
(10) Pub. No.: US 2019/0263437 A1
(43) Pub. Date: Aug. 29, 2019

(54) CARRIER AND CONTROL METHOD THEREOF

(71) Applicant: Panasonic Intellectual Property Management Co., Ltd., Osaka (JP)

(72) Inventors: Tatsuya MIYAZAKI, Osaka (JP); Yuki URATA, Osaka (JP)

(21) Appl. No.: 16/282,523

(22) Filed: Feb. 22, 2019

(30) Foreign Application Priority Data
Feb. 27, 2018 (JP) 2018-033932
Feb. 27, 2018 (JP) 2018-033933

(51) Int. Cl. B62B 5/00; B62B 3/16; G07F 7/06

(52) U.S. Cl. CPC B62B 5/0096; G07F 7/0645; B62B 3/16

(57) ABSTRACT

A shopping basket includes a body, a storage section, a first sensor as a stack sensor, and a controller. The body is configured to hold a transportation object. The storage section is configured to store information. The first sensor is configured to detect occurrence of a stack state where the body and a detection target are stacked relative to each other. The controller is configured to reset the information stored in the storage section when a reset condition including detection of the occurrence of the stack state by the stack sensor is satisfied.

### CROSS-REFERENCE TO RELATED APPLICATIONS

The present application is based upon and claims the benefit of priority of Japanese Patent Application No. 2018-33932, filed on Feb. 27, 2018 and Japanese Patent Application No. 2018-33933, filed on Feb. 27, 2018, the entire contents of which are incorporated herein by reference.

### TECHNICAL FIELD

The present disclosure generally relates to carriers and control methods of the carriers and specifically to a carrier which allows a transportation object to be transported and a control method of the carrier.

### BACKGROUND ART

Document 1 (JP H04-58113 U) describes that a shopping basket used for shopping in supermarkets or the like includes a barcode reader. The shopping basket functions as a carrier which allows goods as transportation objects to be accommodated therein and to be transported.

The shopping basket described in Document 1 reads a barcode provided on each item of goods by the barcode reader to display the total price of the goods on a display. A customer pays the total price displayed on the display at a checkout counter or the like to finish checkout.

In such a carrier, when a previous user forgets to delete information such as the price of goods, confusion of the information with information such as the price of goods to be purchased by a next user may occur.

### SUMMARY

In view of the foregoing, it is an object of the present disclosure to provide a carrier configured to reduce cases where the carrier with remaining information relating to a previous user is used by a next user and a control method of the carrier.

A carrier according to one aspect of the present disclosure includes a body, a storage section, a stack sensor, and a controller. The body is configured to hold a transportation object. The storage section is configured to store information. The stack sensor is configured to detect occurrence of a stack state where the body and a detection target are stacked relative to each other. The controller is configured to reset the information stored in the storage section when a reset condition is satisfied, the reset condition including detection of the occurrence of the stack state by the stack sensor.

A control method of a carrier according to one aspect of the present disclosure is a control method of a carrier including a body, a storage section, and a stack sensor. The control method includes resetting information stored in the storage section when a reset condition is satisfied. The reset condition includes detection of occurrence of a stack state by the stack sensor. The body is configured to hold a transportation object. The storage section is configured to store the information. The stack sensor is configured to detect the occurrence of the stack state where the body and a detection target are stacked relative to each other.

### BRIEF DESCRIPTION OF THE DRAWINGS

FIG. 1 is a block diagram schematically illustrating a configuration of a shopping assistance system according to a first embodiment;

FIG. 2 is an exterior perspective view of shopping baskets stacked on a power supply apparatus in the shopping assistance system;

FIG. 3A is an exterior perspective view of the shopping basket;

FIG. 3B is an enlarged view of an area B1 in FIG. 3A;

FIG. 3C is an enlarged view taken in the direction of arrow C1 in FIG. 3A;

FIG. 4A is am exterior perspective view illustrating placing a first-stage shopping basket on the power supply apparatus in the shopping assistance system;

FIG. 4B is an exterior perspective view illustrating placing a second-stage shopping basket above the power supply apparatus in the shopping assistance system;

FIG. 5 is a flowchart illustrating an operation of the shopping basket;

FIG. 6A is a view illustrating the shopping basket held by a customer;

FIG. 6B is a view illustrating the shopping basket placed on a floor;

FIG. 7A is an exterior perspective view illustrating placing a first-stage shopping basket on a power supply apparatus according to a first variation of the first embodiment;

FIG. 7B is an exterior perspective view illustrating placing a second-stage shopping basket according to the first variation of the first embodiment above the power supply apparatus; and

FIG. 8 is a front view illustrating a cart and power supply apparatus according to a second embodiment.

### DETAILED DESCRIPTION

### First Embodiment

(1) Schema

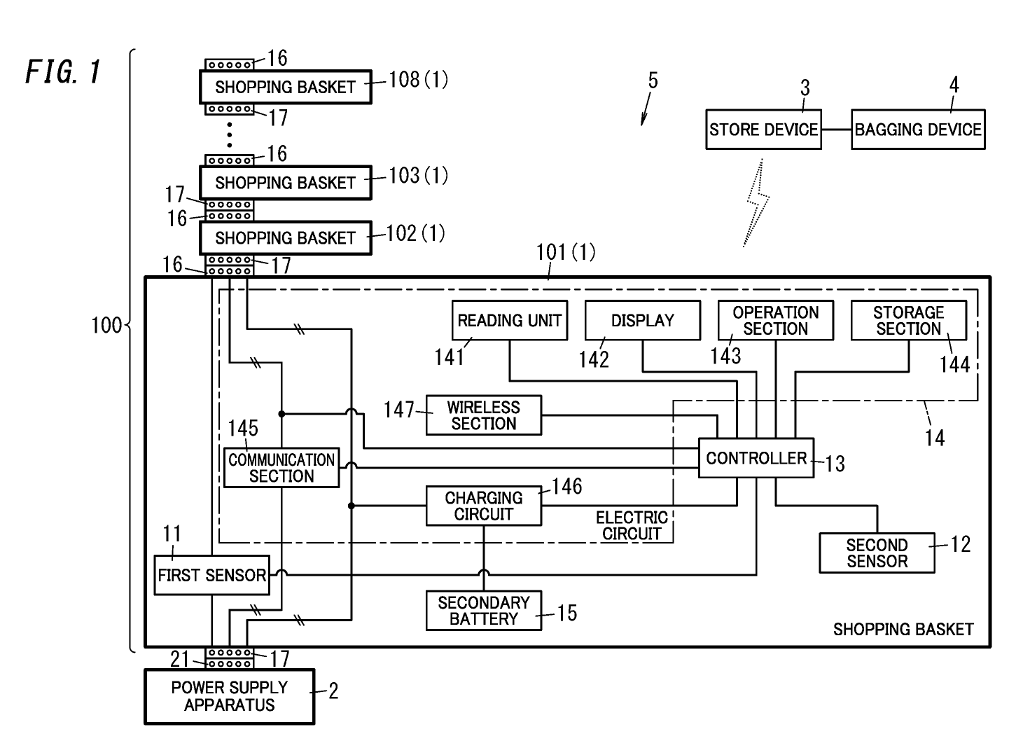

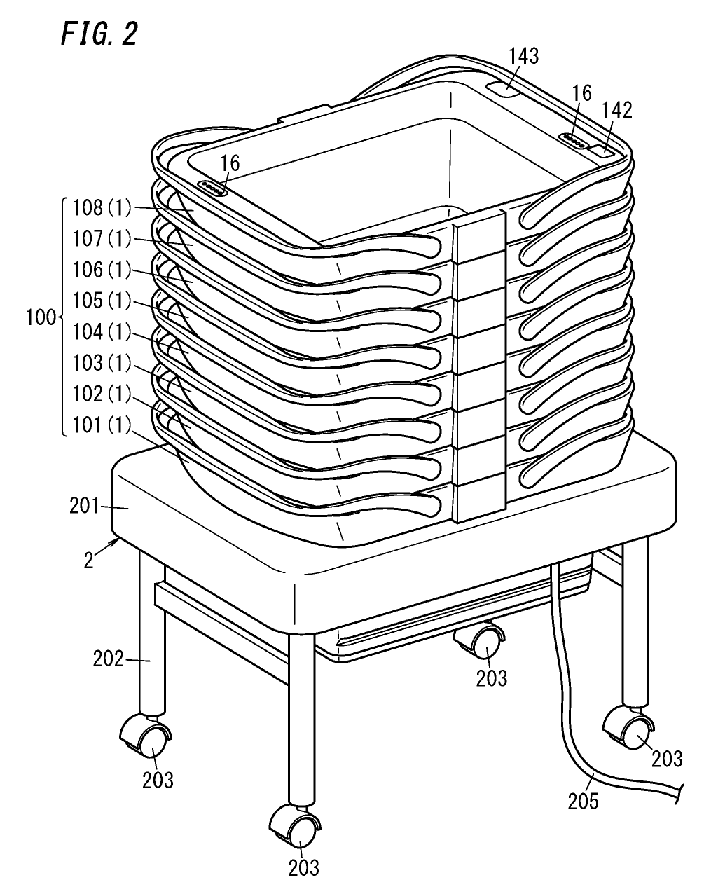

First, a schema of a carrier according to the present embodiment will be described with reference to FIGS. 1 and 2. As used herein, the term “carrier” refers to an apparatus which allows an object (transportation object) to be transported, that is, carried from one place to another and allows the transportation object to be moved together with the carrier which holds the transportation object. Specifically, the carrier is, for example, a container, such as a basket or tableware, that holds a transportation object by accommodating the transportation object therein, or a cart, a tray, a dish, a hand truck, or the like that holds a transportation object by mounting the transportation object thereon.

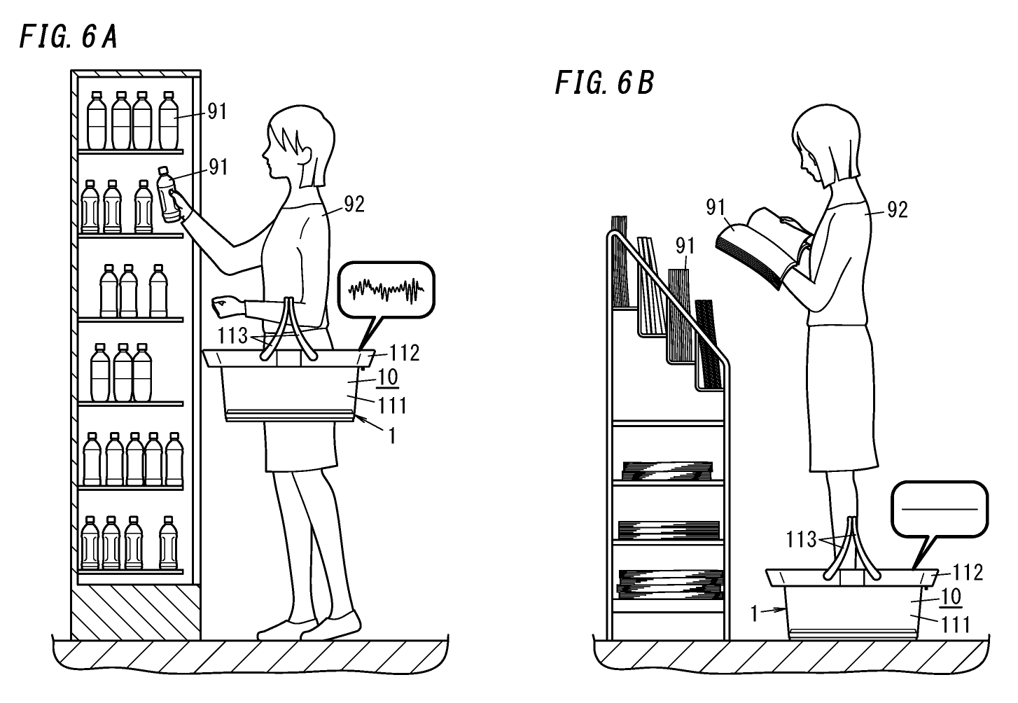

In the present embodiment, an example in which carriers are shopping baskets 101 to 108 will be described. In the following description, when the plurality of (here, for example, eight) shopping baskets 101 to 108 are not particularly distinguished from one another, each of the plurality of shopping baskets 101 to 108 is referred to as a “shopping basket 1”. The shopping basket 1 serving as the carrier is used in, for example, a convenience store, a supermarket, a department store, a drugstore, an electronics retail store, and a retail store such as a home center (hardware store). Such a carrier (shopping basket 1) is used to transport one or more goods (products) 91 (see FIG. 6A) sold in a store. That is, in the present embodiment, transportation objects are the goods 91. The shopping basket 1 is an electronic apparatus including an electric circuit 14 and a secondary battery 15. The electric circuit 14 includes a reading unit 141 or the like. The secondary battery 15 serves as a power supply for operation of the electric circuit 14.

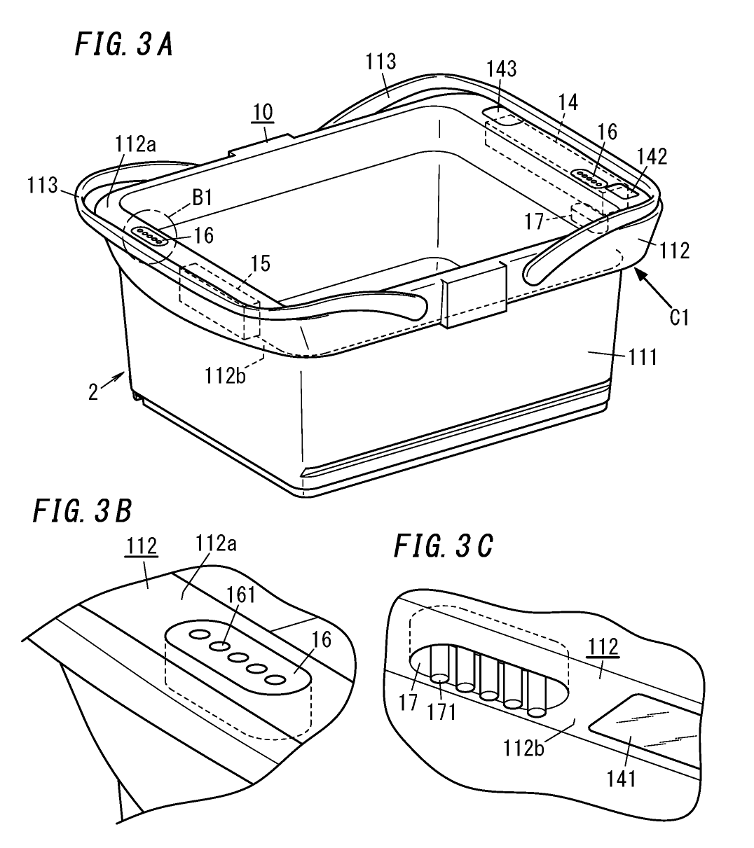

The shopping basket 1 assumed to be the carrier in this embodiment, together with a store device 3, forms a shopping assistance system 5 introduced in a store to assist a customer 92 (see FIG. 6A) in shopping. The store device 3 is installed in, for example, a checkout counter in the store and has a function such as a checkout process. The shopping basket 1 includes a body 10 (see FIG. 3A), the reading unit 141, a storage section 144, and a wireless section 147. The body 10 allows at least goods 91 to be put in. The reading unit 141 is configured to read respective pieces of goods information (product information) on the goods 91. The storage section 144 is configured to store the respective pieces of goods information read. When being placed on the checkout counter, the shopping basket 1 transmits the pieces of goods information from the wireless section 147 to the store device 3. Thus, in the store device 3, a checkout process of the goods 91 becomes possible based on the respective pieces of goods information received from the shopping basket 1.

A store which the shopping basket 1 is introduced into enables the customer 92 to finish purchasing goods 91 by a series of actions of picking up the goods 91 in the store, putting them in the shopping basket 1, and performing checkout thereof with the store device 3. That is, the shopping basket 1 is configured to read goods information, and therefore, at a time point at which each of the goods 91 is put in the body 10 of the shopping basket 1, goods information on each of the goods 91 is acquirable by the shopping basket 1. The respective pieces of goods information on the goods 91 put in the shopping basket 1 may be transmitted from the shopping basket 1 to the store device 3 and may be used for the checkout process and the like. Thus, in stores which the shopping basket 1 is introduced into, it is possible to reduce, for example, a time from the start of the checkout process to reception of the goods 91 by the customer 92 while saving the labor of employees (clerks) in the stores and labor of the customer 92, thereby reducing a time which the customer 92 takes for shopping.

The customer 92 arrived at the store finds the shopping basket 1 placed in, for example, a basket area defined near an entrance of the store in a similar manner to a general shopping basket without an electric circuit 14. While the shopping basket 1 is used, that is, while the customer 92 is shopping, the shopping basket 1 taken out of the basket area is held by a hand of the customer 92 who moves in the store, or the shopping basket 1 is used by being mounted on a cart. When the customer 92 finishes shopping, and all the goods are discharged from the body 10, the shopping basket 1 is returned to the basket area.

In the present embodiment, a power supply apparatus 2 is installed in the basket area. The plurality of shopping baskets 1 are placed on the power supply apparatus 2 in a row, thereby forming a standby group 100. That is, the power supply apparatus 2 charges the secondary batteries 15 of the plurality of shopping baskets 1 forming the standby group 100 and being stacked along the vertical direction (gravity direction) in the basket area.

In the shopping basket 1 used in such a mode, power consumption by the electric circuit 14 is preferably reduced, for example, in a state where the shopping basket 1 is placed in the basket area, that is, in a state where the body 10 is stacked on the power supply apparatus 2. That is, the body 10 of the shopping basket 1 and the power supply apparatus 2 or another shopping basket 1 are stackable relative to each other. In a state where the body 10 of the shopping basket 1 and the power supply apparatus 2 or another shopping basket 1 are stacked relative to each other (hereinafter referred to as a “stack state”), the power consumption by the electric circuit 14 is preferably reduced. Thus, the shopping basket 1 according to the present embodiment adopts the following configuration.

That is, the electric circuit 14 includes at least two operation modes, namely, a normal mode and a power saving mode. The power saving mode is an operation mode in which power consumption (by the electric circuit 14) is less than in the normal mode. Moreover, the shopping basket 1 further includes a first sensor 11 as a stack sensor and a controller 13. The first sensor 11 detects occurrence of the stack state where the body 10 and a detection target (the power supply apparatus 2 or another shopping basket 1) are stacked relative to each other. If the first sensor 11 detects the occurrence of the stack state, the controller 13 switches the operation mode of the electric circuit 14 from the normal mode to the power saving mode.

As a result, while the shopping basket 1 (carrier) is unused, that is, while the shopping basket 1 is not used to transport the goods 91, it is possible to reduce the power consumption by the electric circuit 14 of the shopping basket 1, and it is possible to reduce unnecessary power consumption by the electric circuit 14.

Moreover, in the present embodiment, the controller 13 resets (goods) information stored in the storage section 144 when a reset condition is satisfied. The reset condition includes detection of the occurrence of the stack state by the first sensor 11. As used herein, the term “reset” includes both deleting information from the storage section 144 and switching the state of information stored in the storage section 144 from a “set state” to a “reset state”.

As a result, while the shopping basket 1 (carrier) is unused, that is, while the shopping basket 1 is not used to transport the goods 91, the information stored in the storage section 144 is automatically reset. Thus, even in a case where unspecific customers 92 use the shopping basket 1, it is possible to reduce cases where the shopping basket 1 with remaining information regarding a previous user (customer 92) is used by a next user (customer 92).

(2) Details

The configuration of the shopping basket 1 (carrier) according to the present embodiment will be described in detail below. In the present embodiment, a shopping basket 1 used in a convenience store will be described as an example.

(2.1) Shopping Assistance System

In this embodiment, first, an overall structure of the shopping assistance system 5 including the shopping basket 1 according to the present embodiment will be described with reference to FIG. 1. The shopping assistance system 5 includes the plurality of (in this embodiment, eight) shopping baskets 1 serving as carriers, one power supply apparatus 2, and the store device 3. Moreover, the shopping assistance system 5 further includes a bagging device 4.

In the present embodiment, the store device 3 is installed in a checkout counter in a store (convenience store). The store device 3 has a communication function with the shopping basket 1. When the shopping basket 1 is placed in a checkout space of the checkout counter, the store device 3 communicates with the shopping basket 1 so as to acquire goods information from the shopping basket 1.

In this embodiment, when the customer 92 picks up an item of goods 91 in a store and puts it in the shopping basket 1, the customer 92 causes the reading unit 141 of the shopping basket 1 to read goods information on the item of goods 91. The shopping basket 1 stores the goods information read from the item of goods 91 by the reading unit 141 in the storage section 144. Thus, when one item of goods 91 is put in the shopping basket 1, one piece of goods information on the one item of goods 91 is stored in the storage section 144 of the shopping basket 1. Similarly, when goods 91 are put in the shopping basket 1, respective pieces of goods information on the goods 91 are stored in the storage section 144 of the shopping basket 1. When being placed in the checkout space of the checkout counter, the shopping basket 1 transmits the goods information (the one piece of goods information or the respective pieces of goods information) stored in the storage section 144 from the wireless section 147 to the store device 3.

The store device 3 thus acquires the goods information transmitted from the shopping basket 1, thereby acquiring the respective pieces of goods information on the goods 91 put in the shopping basket 1. Thus, it is no longer necessary to read the respective pieces of goods information on the goods 91 stored in the shopping basket 1 at the checkout counter. Based on the respective pieces of goods information acquired from the shopping basket 1, the store device 3 executes the checkout process of the goods 91. Thus, store which the shopping basket 1 is introduced into, it is possible to reduce, for example, a time from the start of the checkout process to reception of the goods 91 by the customer 92 while saving the labor of employees (clerks) in the stores and labor of the customer 92, thereby reducing a time which the customer 92 takes for shopping.

The bagging device 4 is a device configured to perform “bagging” of moving the goods 91 from the shopping basket 1 into a takeout container. Examples of the takeout container include a bag, a basket, a box, a cart, and a sack. In the present embodiment, as an example, the takeout container is assumed to be a shopping bag (a so-called plastic shopping bag) made of polyethylene or polypropylene. That is, the goods 91 after completion of the checkout process thereof are to be moved from the shopping basket 1 to a takeout container (in this embodiment, a shopping bag) so as to be taken home by the customer 92. This requires a “bagging” action of moving the goods 91 from the shopping basket 1 into the shopping bag. In the present embodiment, the “bagging” action is automatically performed by the bagging device 4 and thus, does not have to be performed by clerks or the customer 92.

The bagging device 4 is, for example, built in the checkout counter. The bagging device 4 includes, for example, a mechanism configured to open and close a bottom panel of the body 10 of the shopping basket 1. When the shopping basket 1 is placed in the checkout space of the checkout counter, the bagging device 4 opens the bottom panel of the body 10 of the shopping basket 1 to discharge the goods 91 through the bottom of the body 10 of the shopping basket 1. When the goods 91 are discharged through the bottom of the shopping basket 1, the bagging device 4 bags the goods 91 into the shopping bag at the checkout counter. Thus, in a state where the shopping basket 1 is placed in the checkout space of the checkout counter, bagging of the goods 91 is completed at the checkout counter. Thereafter, in a state where the shopping basket 1 is removed from the checkout space, the bagging device 4 discharges the goods 91 being in a bagged state, that is, being accommodated in a shopping bag into the checkout space of the checkout counter. Thus, the customer 92 can bring back the goods 91 which are placed on the checkout counter and which are in a bagged state.

The bagging device 4 communicates with the store device 3 to be interlocked with the store device 3. That is, the bagging device 4 has a communication function with the store device 3. In the present embodiment, when the shopping basket 1 is placed in a checkout space, the shopping assistance system 5 first communicates with the shopping basket 1 via the store device 3 to acquire the goods information from the shopping basket 1 by the store device 3. After the acquisition of the goods information is completed, the store device 3 transmits a bagging start signal to the bagging device 4. When receiving the bagging start signal from the store device 3, the bagging device 4 starts “bagging” the goods 91. Then, when the checkout process by the store device 3 is completed, and the shopping basket 1 is removed from the checkout space, the store device 3 transmits a discharge start signal to the bagging device 4. When receiving the discharge start signal from the store device 3, the bagging device 4 discharges the goods 91 in a bagged state into the checkout space.

According to the shopping assistance system 5, placing the shopping basket 1 in the checkout space of the checkout counter starts the bagging of the goods 91, and while the customer 92 performs the checkout process, the bagging of the goods 91 is completed, and after the completion of the checkout process, the goods 91 can be received by the customer 92. Thus, no intervention by the customer 92 and clerks is involved in processes after the customer 92 places the shopping basket 1 in a checkout space of the checkout counter until the customer 92 receives the goods 91 in the bagged state except for the checkout process. Thus, as compared to conventional shopping during which operations such as reading of the goods information and bagging are performed by the customer 92 or clerks, the labor of the customer 92 and the labor of the clerks are reduced.

In the shopping assistance system 5 according to the present embodiment, retrieval (removal) of the shopping basket 1 from the checkout space is basically performed by the customer 92 himself/herself. Specifically, when the discharging of the goods 91 from the shopping basket 1 is completed, the bagging device 4 closes the bottom panel of the shopping basket 1. Thereafter, for example, the store device 3 performs notification to prompt the retrieval of the shopping basket 1 by means of display, voice, or the like. When receiving the notification, the customer 92 moves the shopping basket 1 which is empty and which is placed in the checkout space to the basket area.

In this embodiment, a basket area for retrieved baskets is preferably defined near the checkout counter separately from the basket area near the entrance of the store. In this way, the customer 92 only have to move the shopping basket 1 which is empty and which is placed in the checkout space of the checkout counter to the basket area for retrieved baskets defined near the checkout counter, and the customer 92 does not have to move the empty shopping basket 1 to the basket area near the entrance of the store. In each basket area, the power supply apparatus 2 is provided, and when the shopping basket 1 is returned to the basket area, the power supply apparatus 2 is stacked with the shopping basket 1. When the store device 3 or the bagging device 4 detects that the shopping basket 1 is thus retrieved from the checkout space and the checkout process by the store device 3 is completed, the store device 3 transmits the discharge start signal to the bagging device 4.

Thus, since the customer 92 retrieves the shopping basket 1 by himself/herself, a device configured to retrieve the shopping basket 1 is no longer necessary, which simplifies the configuration of the shopping assistance system 5. Moreover, the customer 92 can retrieve the shopping basket 1 during a series of actions for receiving the goods 91, and therefore, even though the retrieval of the shopping basket 1 is performed by the customer 92 himself/herself, an increase of the labor of the customer 92 is suppressed to a relatively low degree.

In this embodiment, the shopping basket 1 includes the secondary battery 15 as a power supply for operation of the electric circuit 14 including the reading unit 141 and the like. That is, electric power for the operation of the shopping basket 1 (electric circuit 14) during use of the shopping basket 1 is supplied by the secondary battery 15, and therefore, after the use of the shopping basket 1, the shopping basket 1 (secondary battery 15) has to be charged. Thus, the shopping assistance system 5 according to the present embodiment charges the shopping basket 1 placed in the basket area by the power supply apparatus 2.

In general, a plurality of shopping baskets 1 are introduced into one store, and therefore, the shopping assistance system 5 has to charge the plurality of shopping baskets 1. The plurality of shopping baskets 1 may be charged individually, but in that case, the number of power supply facilities required increases, and an area occupied by the basket area increases.

Thus, the shopping assistance system 5 according to the present embodiment is, as illustrated in FIG. 2, configured such that the plurality of shopping baskets 1 are charged in a state where the plurality of shopping baskets 1 are stacked in a row (stacked state). That is, in the shopping assistance system 5 according to the present embodiment, one power supply apparatus 2 (charging facility) placed in the basket area charges the plurality of shopping baskets 1 stacked in the vertical direction (gravity direction). In other words, the plurality of shopping baskets 1 are stacked in a row on the power supply apparatus 2 to form a standby group 100. The power supply apparatus 2 charges the standby group 100 including a shopping basket 1 or a plurality of shopping baskets 1 stacked in the basket area.

In this embodiment, the power supply apparatus 2 and the plurality of shopping baskets 1 are daisy-chained to each other for a supply path of at least charging electric power with the power supply apparatus 2 as an uppermost node. In other words, when attention is focused on the supply path of the charging electric power, the plurality of shopping baskets 1 are connected to the power supply apparatus 2 in a row, wherein when viewed from each of the plurality of shopping baskets 1, one side close to the power supply apparatus 2 is an “upper” side, and the other side away from the power supply apparatus 2 is a “lower” side. In the present disclosure, when viewed from each of the power supply apparatus 2 and the plurality of shopping baskets 1, an upper node (the power supply apparatus 2 or a shopping basket 1) directly connected thereto is referred to as an “adjacent upper node”. Similarly, when viewed from each of the power supply apparatus 2 and the plurality of shopping baskets 1, a lower node (a shopping basket 1) directly connected thereto is referred to as an “adjacent lower node”. Thus, when the shopping basket 101 and the shopping basket 102 are stacked on the power supply apparatus 2 in this order, the power supply apparatus 2 is an adjacent upper node of the shopping basket 101, and the shopping basket 102 is the adjacent lower node of the shopping basket 101. Thus, it is possible to charge the plurality of shopping baskets 1 by one power supply facility, and it is also possible to reduce a surface occupied by the basket area.

Moreover, in the shopping assistance system 5 according to the present embodiment, the power supply apparatus 2 and each of the plurality of shopping baskets 1 respectively include an output terminal 21 and an output terminal 16 to be connected to an adjacent lower node (see FIG. 1). The power supply apparatus 2 and each of the plurality of shopping baskets 1 is configured to switch between an energized state for outputting the charging electric power and an interruption state for not outputting the charging electric power respectively from the output terminal 21 and the output terminal 16. In the shopping assistance system 5 according to the present embodiment, each of the power supply apparatus 2 and the plurality of shopping baskets 1 is configured to switch from the interruption state to the energized state when succeeding in authentication of the adjacent lower node. Thus, the power supply apparatus 2 and each of the plurality of shopping baskets 1 output the charging electric power respectively from the output terminal 21 and the output terminal 16 only when a shopping baskets 1 as the adjacent lower node is correctly connected to the output terminal 21 and the output terminal 16. Thus, in the shopping assistance system 5 according to the present embodiment, it is possible to reduce cases in which the output terminal 21 or 16 in an exposed state is supplied with an electric current.

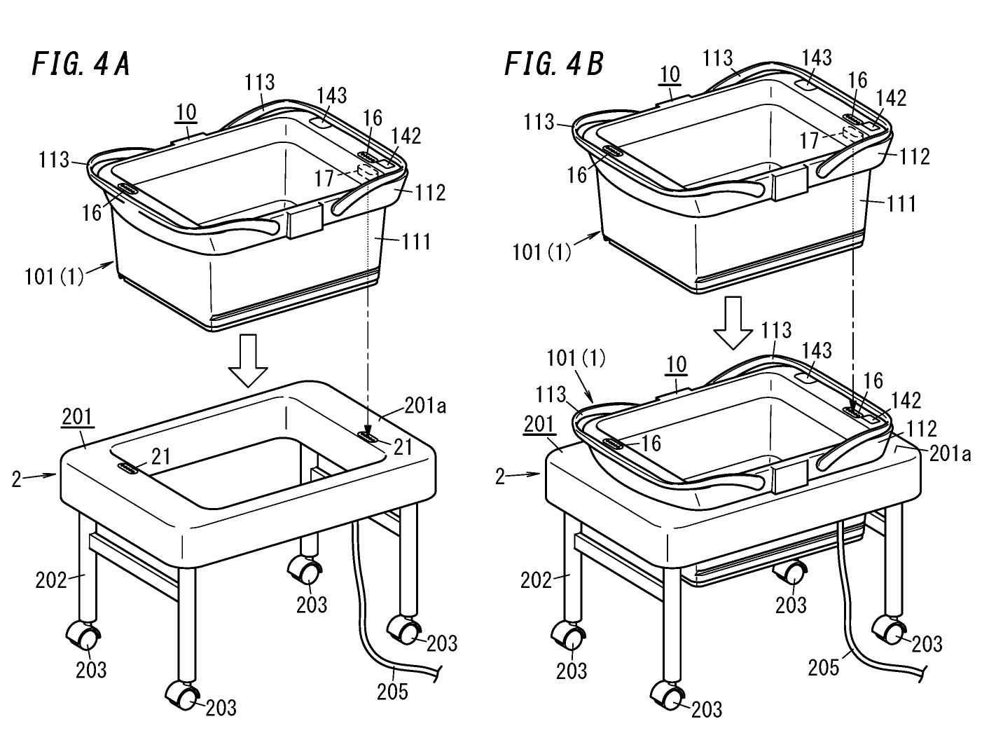

In the basket area, the plurality of shopping baskets 1 are sequentially stacked from the bottom as shown in FIGS. 4A and 4B. Thus, in the following description, an nth shopping basket 1 from a lowermost stage is referred to as an “nth-stage” shopping basket 1 unless otherwise specified (where n is a natural number). That is, as illustrated in FIG. 4A, the shopping basket 101 placed directly on the power supply apparatus 2 is the “first-stage” shopping basket 1, and as illustrated in FIG. 4B, the shopping basket 102 on the shopping basket 101 is referred to as the “second-stage” shopping basket 1.

Moreover, in the present embodiment, the power supply apparatus 2 and the plurality of shopping baskets 1 are daisy-chained with the power supply apparatus 2 serving as the uppermost node not only for the supply path of the charging electric power but also for a communication path. Specifically, each of the plurality of shopping baskets 1 further includes an input terminal 17 in addition to the output terminal 16. The input terminal 17 is to be connected to the output terminal 21 or the output terminal 16 of the adjacent upper node. The input terminal 17 of the first-stage shopping basket 101 is connected to the output terminal 21 of the power supply apparatus 2, and the output terminal 16 of the first-stage shopping basket 101 is connected to the input terminal 17 of the second-stage shopping basket 102. The output terminal 16 of the second-stage shopping basket 102 is connected to the input terminal 17 of the third-stage shopping basket 103.

That is, when an arbitrary shopping basket 1 is defined as a “target node”, the power supply apparatus 2 or a shopping basket 1 connected to the input terminal 17 of the target node is the upper node of the target node, and a shopping basket 1 connected to the output terminal 16 of the target node is the lower node of the target node. In particular, when a plurality of upper nodes are connected to the input terminal 17 of the target node, the power supply apparatus 2 or a shopping basket 1 of the plurality of upper nodes which is adjacent to the target node, that is, the power supply apparatus 2 or a shopping basket 1 directly connected to the input terminal 17 of the target node is the “adjacent upper node”. Similarly, when a plurality of lower nodes are connected to the output terminal 16 of the target node, a shopping basket 1 of the plurality of lower nodes which is adjacent to the target node, that is, a shopping basket 1 directly connected to the output terminal 16 of the target node is the “adjacent lower node”.

Thus, when the power supply apparatus 2 which is the uppermost node is defined as a target node, the first-stage shopping basket 101 is the adjacent lower node of the target node. When the first-stage shopping basket 101 is defined as a target node, the power supply apparatus 2 is the adjacent upper node of the target node, and the second-stage shopping basket 102 is an adjacent lower node of the target node. When the second-stage shopping basket 102 is defined as a target node, the first-stage shopping basket 101 is an adjacent upper node of the target node, and the third-stage shopping basket 103 is an adjacent lower node of the target node. In sum, when viewed from the nth-stage shopping basket 1, an (n−1)th-stage shopping basket 1 serves as an adjacent upper node, and an (n+1)th-stage shopping basket 1 is the adjacent lower node. Note that when n=1, that is, when viewed from the first-stage shopping basket 101, the power supply apparatus 2 but not the shopping basket 1 is the adjacent upper node.

Thus, each of the plurality of shopping baskets 1 included in the standby group 100 is directly connected to the power supply apparatus 2 or is indirectly connected to the power supply apparatus 2 via one or more shopping baskets 1. Thus, the power supply apparatus 2 is configured to supply electric power to the plurality of shopping baskets 1 included in the standby group 100. Each shopping basket 1 is supplied with electric power from the power supply apparatus 2 and charges the secondary battery 15 by a charging circuit 146.

The shopping assistance system 5 according to the present embodiment includes a power supply apparatus 2 and a plurality of shopping baskets 1 serving as carriers as components in addition to the store device 3. Note that as a minimum configuration, the shopping assistance system 5 at least includes one shopping basket 1 as a carrier and one power supply apparatus 2 or another shopping basket 1 as a detection target, wherein the one shopping basket 1 and the detection target are stacked relative to each other. That is, it is not essential for the shopping assistance system 5 that the power supply apparatus 2 is provided or that the shopping basket 1 includes a plurality of shopping baskets 1.

(2.2) Shopping Basket

Next, a configuration of the shopping basket 1 as a carrier will be described with reference to FIGS. 1 to 4B. The plurality of shopping baskets 1 have a common configuration, and therefore, in the following description, a configuration of an arbitrary one shopping basket 1 will be described.

As described above, the shopping basket 1 includes the body 10 (see FIG. 3A), the first sensor 11, the controller 13, the electric circuit 14, the secondary battery 15 (battery), the output terminal 16, and the input terminal 17. Moreover, in the present embodiment, the shopping basket 1 further includes a second sensor 12. In FIG. 1, a circuit configuration of the shopping basket 1 is shown, and the body 10 is omitted.

As illustrated in FIG. 3A, the body 10 includes a housing section 111 in a shape of a box that has at least an opening at the top, a flange 112 disposed around the opening in the housing section 111, and a pair of handles 113. The body 10 allows the goods 91 to be put in the housing section 111. The flange 112 is connected to an upper end of the housing section 111 and has a frame shape surrounding the opening in the housing section 111. Thus, in a state where the body 10 of the shopping basket 1 is placed on another shopping basket 1 or the power supply apparatus 2 serving as an adjacent upper node, the housing section 111 is inserted into a space surrounded by a flange 112 of the another shopping basket 1 or a space surrounded by a frame body 201 (see FIG. 2) of the power supply apparatus 2. In this state, a lower surface 112b of the flange 112 of the shopping basket 1 is in contact with an upper surface 112a of the flange 112 of the another shopping basket 1 serving as an adjacent upper node or an upper surface 201a of the frame body 201 of the power supply apparatus 2 serving as an adjacent upper node. The pair of handles 113 is foldable and has base portions supported by the flange 112.

The electric circuit 14 includes various types of circuit modules configured to operate with electric power supplied from the secondary battery 15. In the present embodiment, as illustrated in FIG. 1, the electric circuit 14 includes a reading unit 141, a display 142, an operation section 143, a storage section 144, a communication section 145, a charging circuit 146, and a wireless section 147.

The reading unit 141 reads respective pieces of goods information on the goods 91 from the goods 91. As used herein, “goods information” is information (goods identification code) for identifying each of the goods 91 and is, for example, a Japanese Article Number (JAN) code or the like used in Japan. Moreover, the goods information is not limited to the information identifying the product type (kind) of each of the goods 91 but may include information such as serial information individually identifying each of the goods 91 of an identical product type. Thus, in the case of goods 91 of an identical product type, the goods 91 of the identical product type are individually identifiable based on the goods information. The reading unit 141 is, for example, a barcode reader, a reader for reading a two-dimensional code, a tag reader, an image sensor, or the like. Herein, the tag reader has a function of reading respective pieces of goods information from a radio frequency (RF) tag provided to goods in a non-contact manner and is included in a radio frequency identification (RFID) system. The reading unit 141 is disposed on a lower surface 112b of the flange 112 (see FIG. 3C).

The display 142 is a 7-segment LED, a liquid crystal display, or the like. The display 142 performs display based on the goods information or the like read by, for example, the reading unit 141. Specifically, the display 142 displays the number of goods 91 on which respective pieces of goods information are stored in the storage section 144. The display 142 is disposed on an upper surface 112a of the flange 112.

The operation section 143 includes, for example, a push button switch and receives an operation performed by the customer 92. Specifically, the operation section 143 receives an operation for causing the operation mode of the reading unit 141 to transition to the return mode for allowing returning (cancellation of purchase) of goods 91 on which respective pieces of goods information have been read by the reading unit 141. That is, when the customer 92 once causes the reading unit 141 to read a piece of goods information on an item of goods 91 with an intention to purchase it but the customer 92 cancels the purchase of the item of goods 91, the customer 92 operates the operation section 143 to allow the item of goods 91 to be returned. The operation section 143 is disposed on the upper surface 112a of the flange 112.

The storage section 144 is, for example, rewritable nonvolatile memory such as electrically erasable programmable read-only memory (EEPROM) or volatile memory such as random access memory (RAM). Moreover, the storage section 144 may be realized as a combination of nonvolatile memory and volatile memory. The storage section 144 stores at least goods information read by the reading unit 141. The storage section 144 is configured to store a plurality of pieces of goods information. Therefore, when the reading unit 141 reads respective pieces of goods information from the goods 91, the respective pieces of goods information on the goods 91 are stored in the storage section 144. The respective pieces of goods information stored in the storage section 144 are individually resettable, which will be described later in detail.

The communication section 145 is configured to communicate with the power supply apparatus 2. In the present embodiment, as an example, a communication schema of the communication section 145 is serial communication adopting a universal asynchronous receiver transmitter (UART). In this case, the communication section 145 performs two-way communication with the power supply apparatus 2 by using two lines, namely, a transmission (TxD) line and a reception (RxD) line. The plurality of shopping baskets 1 are daisy-chained to the power supply apparatus 2, and therefore, the power supply apparatus 2 communicates with each of the shopping baskets 1 based on addresses assigned to the plurality of shopping baskets 1.

The charging circuit 146 receives electric power from the power supply apparatus 2 to charge the secondary battery 15. In this embodiment, the charging circuit 146 includes a DC/DC converter configured to step down a direct-current voltage applied from the power supply apparatus 2.

The wireless section 147 communicates with the store device 3, for example, via optical wireless communication using light such as infrared radiation or visible radiation as a medium or via wireless communication using a radio wave as a medium. The wireless section 147 has a function of transmitting the goods information stored in at least the storage section 144 to the store device 3.

The electric circuit 14 has at least two operation modes, namely a normal mode and a first power saving mode. In particular, in the present embodiment, the operation mode of the electric circuit 14 further includes a second power saving mode different from the first power saving mode. That is, the operation mode of the electric circuit 14 includes three modes, namely, the normal mode, the first power saving mode, and the second power saving mode.

The first power saving mode is an operation mode in which power consumption (by the electric circuit 14) is less than in the normal mode. Specifically, in the normal mode, all of the reading unit 141, the display 142, the operation section 143, the storage section 144, the communication section 145, the charging circuit 146 and the wireless section 147 of the electric circuit 14 are in an energized state. In contrast, in the first power saving mode, supplying power to at least the reading unit 141 and the display 142 of the electric circuit 14 is stopped. In this way, the power consumption by the electric circuit 14 in the first power saving mode is less than in the normal mode by the power consumption by at least the reading unit 141 and the display 142. The second power saving mode is an operation mode in which power consumption (by the electric circuit 14) is less than in the normal mode and which is different from the first power saving mode. Similarly to the first power saving mode, in the second power saving mode, supplying power to at least the reading unit 141 and the display 142 of the electric circuit 14 is stopped.

In this embodiment, a trigger for switching the operation modes is different between the first power saving mode and the second power saving mode. The operation mode of the electric circuit 14 is switched by the controller 13. A switching operation of the operation mode by the controller 13 will be described in detail in “(3) Operation”.

The secondary battery 15 is, for example, a lithium ion battery. The secondary battery 15 supplies electric power to the electric circuit 14 so as to operate the electric circuit 14. Moreover, in the present embodiment, the secondary battery 15 supplies electric power for operation to electric elements (or circuit modules) such as the first sensor 11, the second sensor 12, and the controller 13 in addition to the electric circuit 14.

The output terminal 16 is, in the present embodiment, for example, a connector including a total of five contacts, namely, a pair of (Vcc and GND) contacts for outputting charging electric power, a pair of (T×D and R×D) contacts for communication, and a contact 161 for detection. The output terminal 16 has a function of outputting the charging electric power by being electrically connected to at least another shopping basket 1. The contact 161 for detection functions as a connection terminal for detection of occurrence of a stack state with respect to the adjacent lower node. As illustrated in FIG. 3B, the output terminal 16 is disposed on the upper surface 112a of the flange 112. In this embodiment, the output terminal 16 is, for example, a pad connector and is configured to expose one surface of each contact fixed to the body 10 at the upper surface 112a of the flange 112.

The input terminal 17 is connected to the output terminal 16 or 21 of the adjacent upper node and is thus a connector having a total of five contacts corresponding to the output terminals 16. That is, the input terminal 17 includes a total of five contacts, namely, a pair of (Vcc and GND) contacts for receiving charging electric power, a pair of (T×D and R×D) contacts for communication, and a contact 171 for detection. The input terminal 17 receives the charging electric power by being electrically connected to at least the power supply apparatus 2 or another shopping basket 1. The contact 171 for detection functions as a connection terminal for detection of occurrence of a stack state with respect to the adjacent upper node. As illustrated in FIG. 3C, the input terminal 17 is disposed on the lower surface 112b of the flange 112. More specifically, the input terminal 17 is placed in a location to face the output terminal 16 or 21 of an adjacent upper node (another shopping basket 1 or the power supply apparatus 2) in a state where the body 10 of the shopping basket 1 is placed on the another shopping basket 1 or the power supply apparatus 2 as the adjacent upper node.

In this embodiment, the input terminal 17 is, for example, a spring pin connector adopting a spring probe, and when the input terminal 17 is connected to the output terminal 16 or 21, the input terminal 17 exerts elastic force on each contact to press each contact against the output terminal 16 or 21. In this way, in a state where the body 10 of the shopping basket 1 is placed on another shopping basket 1 or the power supply apparatus 2 as an adjacent upper node, the input terminal 17 is in contact with the output terminal 16 or 21 of the adjacent upper node (the another shopping basket 1 or the power supply apparatus 2) at a contact pressure of a certain level or higher. Thus, as illustrated in FIGS. 4A and 4B, simply placing the body 10 of the shopping basket 1 on another shopping basket 1 or the power supply apparatus 2 as an adjacent upper node secures an electrical connection between the input terminal 17 and the output terminal 16 or 21.

In the present embodiment, a plurality of (in this embodiment, two) output terminals 16 are provided to one body 10. The two output terminals 16 are disposed at locations around the opening in the flange 112 so as to be point-symmetric with a center point of the opening as a point of symmetry. Thus, both in a case where the shopping basket 102 is placed on the body 10 in an orientation shown in FIG. 4B and in a case where the shopping basket 102 is placed in an orientation opposite to the orientation in FIG. 4B, the input terminal 17 of another shopping basket 1 is connectable to the output terminal 16.

The first sensor 11 is a stack sensor. The first sensor 11 as the stack sensor detects occurrence of a “stack state” where, as described above, the body 10 and the detection target (power supply apparatus 2 or another shopping basket 1) are stacked relative to each other. That is, when the body 10 of the shopping basket 1 and the power supply apparatus 2 or the body 10 of another shopping basket 1 as the detection target are stacked relative to each other, the first sensor 11 detects the occurrence of the stack state, and a sensed result by the first sensor 11 changes from “absence of stack” to “presence of stack”. For example, when the first-stage shopping basket 101 is stacked on the power supply apparatus 2 installed in the basket area, the first sensor 11 of the shopping basket 101 detects occurrence of the stack state with respect to the power supply apparatus 2 as the detection target. Moreover, when the second-stage shopping basket 102 is stacked on the first-stage shopping basket 101, the first sensor 11 of the shopping basket 102 detects occurrence of the stack state with respect to the shopping basket 101 as the detection target. At this time, also the first sensor 11 of the shopping basket 101 detects occurrence of the stack state with respect to the shopping basket 102 as the detection target.

In the present embodiment, the first sensor 11 detects the presence or absence of the stack state based on the presence or absence of an electrical connection of a connection terminal provided to the body 10 to a counter terminal provided to a detection target. That is, when an electrical connection between the shopping basket 1 and the detection target is present, the first sensor 11 detects occurrence of the stack state. Specifically, the first sensor 11 detects the presence or absence of a connection of the input terminal 17 (counter terminal) of an adjacent lower node (another shopping basket 1) to the contact 161 for detection (connection terminal) of the output terminal 16. Moreover, the first sensor 11 detects the presence or absence of a connection of the output terminal 21 or 16 (counter terminal) of an adjacent upper node (power supply apparatus 2 or another shopping basket 1) to the contact 171 for detection (connection terminal) of the input terminal 17.

In other words, the stack state includes a first stack state in which the body 10 is stacked on a detection target and a second stack state in which a detection target is stacked on the body 10. A state where the body 10 is stacked on an adjacent upper node (power supply apparatus 2 or another shopping basket 1) is a first stack state, and a state where an adjacent lower node (another shopping basket 1) is stacked on the body 10 is a second stack state. In the present embodiment, the first sensor 11 is configured to detect occurrence of the stack state for both the first stack state and the second stack state.

As an example, the first sensor 11 determines whether or not another shopping basket 1 is connected to the contact 161 (connection terminal) based on a signal level of an Interrupt ReQuest (IRQ) signal input to the contacts 161 and 171. In the present embodiment, the first sensor 11 detects the occurrence of the stack state (second stack state) with respect to the adjacent lower node when the potential of the contact 161 has a prescribed value. Similarly, the first sensor 11 detects the occurrence of the stack state (first stack state) with respect to the adjacent upper node when the potential of the contact 171 has a prescribed value.

In the present embodiment, two output terminals 16 are provided to one body 10 as described above. Therefore, the first sensor 11 detects the stack state from potentials of the contacts 161 and 171 for detection of a total of three terminals, namely the two output terminals 16 and one input terminal 17. In this embodiment, when the potential of at least one of the three contacts 161 and 171 has a prescribed value, the sensed result by the first sensor 11 is the “stack state”. In contrast, when the potentials of all the three contacts 161 and 171 have values other than the prescribed value, the sensed result by the first sensor 11 is “non-stack state”.

The second sensor 12 detects occurrence of a prescribed event. As used herein, “prescribed event” is an event different from the “stack state” to be detected by the first sensor 11. In the present embodiment, an event as the detection target of the second sensor 12 is that a movement state of the body 10 satisfies a prescribed determination condition. Specifically, the second sensor 12 includes a sensor such as an acceleration sensor, a vibration sensor, a gyroscope sensor, or an inclination sensor to determine the movement state of the body 10. The body 10 is moved by the customer 92 with the body 10 being held by a hand of the customer 92 or with the body 10 mounted on a shopping cart or the like. Therefore, while the body 10 is being moved, a change in acceleration, vibration, position, and the like influences the body 10 at a certain level or higher. In contrast, when the body 10 is in a still state, for example, the body 10 is free from a hand of the customer 92 and is placed on the floor, the change in acceleration, vibration, position, and the like does not occur.

When the magnitude of the change in acceleration, vibration, position, and the like of the body 10 is greater than or equal to a threshold, the sensed result by the second sensor 12 is the “movement state”. In contrast, when the magnitude is less than the threshold, the sensed result by the second sensor 12 is the “still state”. In the present embodiment, the prescribed determination condition means that the body 10 is in the “still state”. Thus, when the sensed result by the second sensor 12 is the “still state”, the second sensor 12 determines that the movement state of the body 10 satisfies the prescribed determination condition, and determines the occurrence of the prescribed event.

The controller 13 controls the first sensor 11, the second sensor 12, the electric circuit 14, and the like. The controller 13 includes a computer (including a microcontroller) as a main component. The computer includes, for example, a processor and memory. That is, the computer functions as the controller 13 by causing the processor to execute an appropriate program stored in the memory. The functions of the controller 13 will be described in detail in “(3) Operation”.

Moreover, the shopping basket 1 may further include, for example, a voice outputter and various types of sensors in addition to the above-described configuration. For example, when the shopping basket 1 includes an optical sensor such as an optical curtain or a sensor such as a weight sensor, the sensor can detect the presence or absence of accommodated objects in the body 10. That is, these sensors are configured to detect a holding state of the transportation objects (goods 91) by the body 10.

(2.3) Power Supply Apparatus

Next, a configuration of the power supply apparatus 2 will be described with reference to FIGS. 4A and 4B. The power supply apparatus 2 is placed, for example, in a basket area defined near an entrance or a checkout counter of a store. In particular, the power supply apparatus 2 described as an example in the present embodiment includes casters 203 and is movable on a floor surface, and therefore, an installation place of the power supply apparatus 2 is easily changed.

As illustrated in FIG. 4A, the power supply apparatus 2 includes the frame body 201, a support member 202, casters 203, a power supply cable 205, and the output terminal 21.

The frame body 201 has a frame shape with an opening penetrating in the vertical direction (gravity direction). In the present embodiment, the frame body 201 has a rectangular frame shape. The support member 202 supports the frame body 201 at a location away from the floor surface by a certain distance. The casters 203 are attached to lower ends of the support member 202. The power supply cable 205 is drawn out of the frame body 201. The power supply cable 205 is a cable for supplying power to an internal circuit in the power supply apparatus 2 and is connected to, for example, an outlet.

In the frame body 201, an internal circuit is built. The internal circuit supplies, to the plurality of shopping baskets 1 included in the standby group 100, electric power (charging electric power) required to charge the secondary battery 15. In the present embodiment, the internal circuits in the power supply apparatus 2 includes an AC/DC converter configured to convert an alternating-current voltage into a direct-current voltage and supplies the direct-current voltage to the plurality of shopping baskets 1. Note that the internal circuits in the power supply apparatus 2 are not limited to this embodiment and may have a configuration in which the AC/DC converter is not provided and the alternating-current voltage or the direct-current voltage externally applied is directly supplied to the plurality of shopping baskets 1.

In the present embodiment, the output terminal 21 is, for example, a connector including a total of five contacts, namely a pair of (Vcc and GND) contacts for outputting charging electric power, a pair of (T×D and R×D) contacts for communication, and a contact for detection. As illustrated in FIG. 4A, the output terminal 21 is disposed on the upper surface 201a of the frame body 201. In this embodiment, the output terminal 21 is, for example, a pad connector and is configured to expose one surface of each contact fixed to the frame body 201 from the upper surface 201a of the frame body 201.

Similarly to the output terminal 16 of the shopping basket 1, in the present embodiment, a plurality of (in this embodiment, two) output terminals 21 of the power supply apparatus 2 are provided to one frame body 201. The two output terminals 21 are disposed at locations around the opening in the frame body 201 so as to be point-symmetric with a center point of the opening as a point of symmetry. Thus, both in a case where the shopping basket 1 is placed on the power supply apparatus 2 in an orientation shown in FIG. 4A and in a case where the shopping basket 1 is placed in an orientation opposite to the orientation in FIG. 4A, the input terminal 17 of the shopping basket 1 is connectable to the output terminal 21.

In the present embodiment, the charging circuit 146 (see FIG. 1) configured to charge the secondary battery 15 is provided to the shopping basket 1. Therefore, the power supply apparatus 2 outputs a charge control command for controlling the charging to the shopping basket 1, thereby indirectly controlling the operation of the charging circuit 146. The power supply apparatus 2 transmits the charge control command to the shopping basket 1. In the shopping basket 1 which receives the charge control command, the controller 13 controls the charging circuit 146 in accordance with the charge control command. That is, the power supply apparatus 2 indirectly, but not directly, controls the charging of the shopping basket 1.

(3) Operation

The operation of the shopping basket 1 according to the present embodiment will be described below.

(3.1) Basic Operation

First, basic operation of the shopping basket 1 will be described.

When the customer 92 picks up goods 91 in a store and puts them in the shopping basket 1, the customer 92 cause the reading unit 141 of the shopping basket 1 to read respective pieces of goods information on the goods 91. The shopping basket 1 stores the respective pieces of goods information read from the goods 91 by the reading unit 141 in the storage section 144. Thus, when one or more items of goods 91 are put in the shopping basket 1, one or more pieces of goods information on the one or more items of goods 91 are stored in the storage section 144 of the shopping basket 1. As an example, the storage section 144 stores pieces of goods information as time series in the order of reading by the reading unit 141.

Thereafter, when being placed in a checkout space of the checkout counter, the shopping basket 1 transmits the (one or more pieces of) goods information stored in the storage section 144 to the store device 3 by the wireless section 147. In this embodiment, when the storage section 144 stores a plurality of pieces of goods information, the wireless section 147 collectively transmits the plurality of pieces of goods information stored in the storage section 144 to the store device 3 or divides the plurality of pieces of goods information stored in the storage section 144 into a plurality of packets and transmits the packets to the store device 3. When all the plurality of pieces of goods information stored in the storage section 144 are transmitted to the store device 3, the plurality of pieces of goods information stored in the storage section 144 are collectively reset.

When the customer 92 wishes to return (cancel the purchase of) the goods 91 during shopping, the customer 92 operates the operation section 143. Each time the operation section 143 is operated, the controller 13 switches the operation mode of the reading unit 141 between the read mode and the return mode. The operation mode of the reading unit 141 is normally the read mode, and as described above, the respective pieces of goods information read from the goods 91 by the reading unit 141 are stored in the storage section 144. In contrast, when the operation mode of the reading unit 141 is the return mode, the respective pieces of goods information read from the goods 91 by the reading unit 141 are reset.

That is, in a state where a piece of goods information on an item of goods 91 is stored in the storage section 144, the piece of goods information on the item of goods 91 is read by the reading unit 141 operating in the return mode, and thereby, the piece of goods information on the item of goods 91 is reset by the storage section 144. In the present embodiment, the controller 13 deletes the piece of goods information stored in the storage section 144, thereby realizing a reset process of the piece of goods information. Note that goods information to be reset in the return mode is limited to goods information stored in the storage section 144, and goods information not stored in the storage section 144 is not reset.

Even when a plurality of pieces of goods information are stored in the storage section 144, each of the pieces of goods information of the goods 91 is individually resettable by adopting the return mode as described above. Thus, when the customer 92 once causes the reading unit 141 to read a piece of goods information on an item of goods 91 with an intention to purchase it but the customer 92 cancels the purchase of the item of goods 91, the customer 92 operates the operation section 143 so that the reading unit 141 is in the return mode, thereby enabling the piece of goods information to be individually reset. Thus, the customer 92 is allowed to return (cancel purchase of) any item of goods 91 during shopping.

Moreover, the controller 13 may change the display mode of the display 142 or an output sound of a voice outputter depending on whether the operation mode of the reading unit 141 is the read mode or the return mode. For example, in a configuration in which the voice outputter outputs a beep when the reading unit 141 reads goods information, the controller 13 switches the types of the beep depending on the operation mode of the reading unit 141. In this way, it becomes easy for the customer 92 to recognize whether the operation mode of the reading unit 141 is the read mode or the return mode.

In this embodiment, switching the return mode to the read mode is performed not only by the operation performed on the operation section 143 but also, for example, when the reset process is completed, or when a constant time (e.g., 10 seconds) elapses. That is, when the reading unit 141 reads the goods information after the reading unit 141 starts operating in the return mode, and then resetting of the goods information is completed, the operation mode of the reading unit 141 is switched to the read mode without an operation performed on the operation section 143. When a constant time has elapsed without goods information being read by the reading unit 141 after the reading unit 141 starts operating in the return mode, the operation mode of the reading unit 141 is switched to the read mode without an operation performed on the operation section 143.

(3.2) Switching and Resetting of Operation Mode

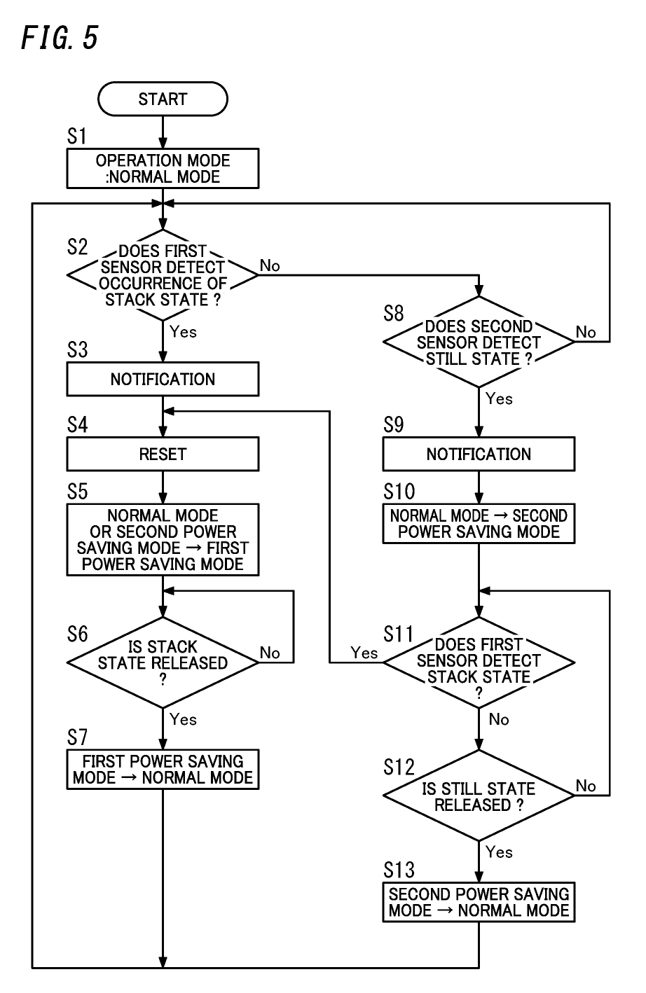

Next, with reference to FIGS. 5 to 6B, switching and resetting operations of the operation mode of the electric circuit 14 in the shopping basket 1 according to the present embodiment will be described.

After being activated, the shopping basket 1 first sets the operation mode of the electric circuit 14 to the normal mode by the controller 13 (51). In the normal mode, as described above, all of the reading unit 141, the display 142, the operation section 143, the storage section 144, the communication section 145, the charging circuit 146 and the wireless section 147 are in an energized state. In this state, when the customer 92 picks up goods 91 in a store and puts them in the shopping basket 1, the customer 92 causes the reading unit 141 to read respective pieces of goods information on the goods 91, thereby storing the respective pieces of goods information on the goods 91 in the storage section 144.

In the shopping basket 1, while the operation mode of the electric circuit 14 is the normal mode, the controller 13 monitors a sensed result by the first sensor 11 (S2). At this time, if the first sensor 11 detects the occurrence of the stack state (S2: Yes), the controller 13 performs a notification process (S3) and a reset process (S4) and then switches the operation mode of the electric circuit 14 from the normal mode to the first power saving mode (S5).

In the notification process (S3), the controller 13 performs a notification of the reset process and executing switching to a (first) power saving mode by, for example, the display 142, the voice outputter, or the like. As an example, in the notification process, a message saying, for example, “Data is reset, and the operation mode transitions to the sleep mode” is output from the voice outputter as an voice output.

In the reset process (S4), the controller 13 collectively resets the pieces of goods information stored in the storage section 144. In the present embodiment, the controller 13 deletes all the pieces of goods information from the storage section 144 to realize a process of collectively resetting the pieces of goods information. That is, in a state where one or more pieces of goods information on one or more items of goods 91 are read by the reading unit 141 and are stored in the storage section 144, the reset process is executed, and thereby, the one or more pieces of goods information on the one or more items of goods 91 are deleted from the storage section 144.

Moreover, in the shopping basket 1, even when the operation mode of the electric circuit 14 is in the first power saving mode, the controller 13 continues monitoring a sensed result by the first sensor 11 (S6). At this time, if the first sensor 11 no longer detects the stack state (S6: yes), the controller 13 switches the operation mode of the electric circuit 14 from the first power saving mode to the normal mode (S7). That is, while the first sensor 11 continues detecting occurrence of the stack state, that is, while the sensed result by the first sensor 11 is the “stack state” (S6: No), the controller 13 sets the operation mode of the electric circuit 14 to the first power saving mode. On the other hand, if the stack state is released and the first sensor 11 no longer detects the stack state, that is, when the sensed result by the first sensor 11 is the “non-stack state” (S6: Yes), the controller 13 sets the operation mode of the electric circuit 14 to the normal mode (S7).

In this embodiment, when the first sensor 11 detects either the first stack state or the second stack state, the controller 13 resets the pieces of goods information (S4) and switches the operation mode of the electric circuit 14 from the normal mode to the first power saving mode (S5). That is, for the sensed result by the first sensor 11, the controller 13 does not particularly distinguish the first stack state from the second stack state and handles the first and second stack states collectively as the occurrence of the stack state (S2: Yes).

Moreover, if the first sensor 11 does not detect the occurrence of the stack state (S2: No), the controller 13 monitors a sensed result by the second sensor 12 (S8). In this embodiment, when the second sensor 12 detects occurrence of an event (S8: Yes), the controller 13 switches the operation mode of the electric circuit 14 from the normal mode to the second power saving mode (S10). In this case, the controller 13 executes a notification process (S9), and then switches the operation mode of the electric circuit 14 from the normal mode to the second power saving mode (S10).

In the present embodiment, when the body 10 is in the “still state”, the second sensor 12 detects the occurrence of the event (S8: Yes). Thus, as illustrated in, for example, FIG. 6A, in a situation in which a customer 92 moves while holding the body 10 of the shopping basket 1 by his/her hand, the sensed result by the second sensor 12 is a “movement state”, and therefore, the second sensor 12 determines the absence of the event (S8: No). In contrast, for example, as illustrated in FIG. 6B, in a situation in which the customer 92 places the body 10 of the shopping basket 1 on a floor, the sensed result by the second sensor 12 is a “still state”, and therefore, the second sensor 12 determines the occurrence of an event (S8: Yes).

In the notification process (S9), the controller 13 notifies that switching to a (second) power saving mode is performed by, for example, the display 142 or the voice outputter. As an example, in the notification process, a message saying, for example, “The operation mode transitions to the sleep mode” is output as a voice output by the voice outputter.

Moreover, in the shopping basket 1, while the operation mode of the electric circuit 14 is the second power saving mode, the controller 13 monitors a sensed result by the first sensor 11 (S11). At this time, if the first sensor 11 detects the occurrence of the stack state (S11: Yes), the controller 13 executes the reset process (S4) and then switches the operation mode of the electric circuit 14 to the first power saving mode (S5). In this case, the operation mode of the electric circuit 14 before being switched is the second power saving mode. Therefore, the controller 13 switches, in the process S5, the operation mode of the electric circuit 14 not from the normal mode but from the second power saving mode to the first power saving mode. For example, a shopping basket 1 which is empty is placed on the floor, and the operation mode of the electric circuit 14 of the shopping basket 1 is switched to the second power saving mode. On this shopping basket 1, another shopping basket 1 is stacked, and then, the operation mode of the electric circuit 14 of the shopping basket 1 which is in a lower stage is switched to the first power saving mode. In this case, the operation mode of the electric circuit 14 of the shopping basket 1 in the lower stage is switched from the normal mode to the second power saving mode and is then switched to the first power saving mode without being switched from the second power saving mode to the normal mode.

It is not essential for the shopping basket 1 to be configured to proceed to the reset process (S4) without performing the notification process (S3) when occurrence of the stack state is detected in the process S11. The notification process (S3) may be performed also when occurrence of the stack state is detected in the process S11. Alternatively, the operation mode of the electric circuit 14 may be switched (S5) from the second power saving mode to the first power saving mode without performing the reset process (S4) when occurrence of the stack state is detected in the process S11.

Moreover, in the shopping basket 1, even when the operation mode of the electric circuit 14 is the second power saving mode, if the first sensor 11 does not detect the occurrence of the stack state (S11: No), the controller 13 continues monitoring the sensed result by the second sensor 12 (S12). At this time, when the second sensor 12 no longer detects the event (S12: Yes), the controller 13 switches the operation mode of the electric circuit 14 from the second power saving mode to the normal mode (S13). That is, when the sensed result by the second sensor 12 is the “still state” (S12: No), the process returns to the process S11, and while the controller 13 maintains the operation mode of the electric circuit 14 to be the second power saving mode, the controller 13 monitors the sensed result by the first sensor 11. In contrast, when the sensed result of the second sensor 12 is “movement state” (S12: Yes), the controller 13 changes the operation mode of the electric circuit 14 to the normal mode (S13).

The shopping basket 1 repeatedly executes the processes of S2 to S13 described above.

Here, in the present embodiment, the charging circuit 146 is configured to charge the secondary battery 15 at least when the operation mode of the electric circuit 14 is the first power saving mode. That is, supplying power to the charging circuit 146 continues also when the operation mode of the electric circuit 14 is the power saving mode, and therefore, charging of the secondary battery 15 by the charging circuit 146 is possible. Moreover, also when the operation mode of the electric circuit 14 is the normal mode or the second power saving mode, the charging circuit 146 can charge the secondary battery 15.

As described above, the sensed result of the first sensor 11 becomes “stack state”, which triggers switching of the operation mode of the electric circuit 14 from the normal mode to the first power saving mode. Moreover, the sensed result by the first sensor 11 becomes “non-stack state”, which triggers switching of the operation mode of the electric circuit 14 from the first power saving mode to the normal mode. In contrast, the sensed result by the second sensor 12 becomes “still state”, which triggers switching of the operation mode of the electric circuit 14 from the normal mode to the second power saving mode. Moreover, the sensed result by the second sensor 12 becomes “movement state”, which triggers switching of the operation mode of the electric circuit 14 from the second power saving mode to the normal mode.

Moreover, if the first sensor 11 detects the occurrence of the stack state (S2: Yes), the reset process (S4) is executed, but when the second sensor 12 detects the occurrence of an event (S8: Yes), the reset process is not executed. That is, the controller 13 collectively resets the pieces of goods information stored in the storage section 144 only when the first sensor 11 detects the occurrence of the stack state (S2: Yes).

After the first sensor 11 detects the occurrence of the stack state (S2: Yes), and before the reset process (S4) is started, the controller 13 may execute a preliminary process. That is, the preliminary process is performed before or after the notification process (S3).

As an example of the preliminary process, the controller 13 starts counting a stand-by time (e.g., 10 seconds) from a time point at which the first sensor 11 detects the occurrence of the stack state. When the first sensor 11 detects a release of the stack state during counting of the stand-by time, that is, when the sensed result by the first sensor 11 becomes “non-stack state”, the controller 13 does not perform the reset process (S4) and proceeds to the process S2. Thus, after the stack state occurs, and before the reset process (S4) and switching to the first power saving mode (S5) are performed, an extension corresponding to a stand-by period is set. In other words, when, after the stack state occurs, the stack state continues over the stand-by time, the controller 13 executes the reset process (S4) and performs switching to the first power saving mode (S5). In this case, the reset condition for executing the reset process (S4) includes continuation of the stack state over the stand-by time in addition to detection of the occurrence of the stack state by the first sensor 11. Thus, if, even when the first sensor 11 detects the occurrence of the stack state, the stack state is released immediately (i.e., before the stand-by time elapses), it is possible to avoid resetting of the pieces of goods information stored in the storage section 144.

As another example of the preliminary process, the controller 13 determines whether or not to execute the reset process (S4) depending on the holding state of the transportation object (goods 91) by the body 10. For example, when an item of goods 91 as a transportation object is put in the body 10, the controller 13 determines that the item of goods 91 is being held by the body 10. When the item of goods 91 is being held by the body 10, the controller 13 does not perform the reset process (S4) and proceeds to the process S2. In other words, only when no goods 91 are put in the body 10, the controller 13 executes the reset process (S4) and performs switching to the first power saving mode (S5). In this case, the reset condition for executing the reset process (S4) includes that no goods 91 are put in the body 10, that is, no goods 91 are held by the body 10 in addition to detection of the occurrence of the stack state by the first sensor 11. Thus, for example, when at least one item of goods 91 remains in the body 10, it is possible to avoid resetting at least a piece of goods information stored in the storage section 144 even when the first sensor 11 detects the occurrence of the stack state.

Moreover, the controller 13 is configured to perform a preliminary process before resetting the information after the reset condition is satisfied, and the preliminary process may vary depending on whether or not the information stored in the storage section 144 has been output. Specifically, the storage section 144 stores a flag indicating a transmission situation of the pieces of goods information, the controller 13 determines the preliminary process to be executed before the reset process (S4) depending on whether the value of the flag is “1” (transmitted) or “0” (not transmitted). For example, if the pieces of goods information are not transmitted to the store device 3, the controller 13 causes the voice outputter to output, as a preliminary process, a message as a voice output such as “Checkout has not been completed. Will you proceed with the process?” so as to indicate that the pieces of goods information are not transmitted. Moreover, if the pieces of goods information are not transmitted to the store device 3, the controller 13 may set, as the preliminary process, an extension corresponding to the stand-by period as described above. In contrast, if the pieces of goods information are transmitted, the controller 13 skips (omits) the notification process (S3) and executes, as the preliminary process, the reset process (S4). In this case, the preliminary process has to be performed before the notification process (S3). That is, basically, if the pieces of goods information are not transmitted to the store device 3, the reset process (S4) is not executed immediately, whereas in a state where the pieces of goods information are transmitted, the reset process (S4) is immediately executed.

As described above, if the first sensor 11 detects the occurrence of the stack state, the controller 13 not only immediately resets the pieces of information stored in the storage section 144, but also resets the pieces of information stored in the storage section 144 after the preliminary process. That is, even when the first sensor 11 detects the occurrence of the stack state, the reset process is not necessarily executed, but in some cases, the reset process is not executed. In sum, when the reset condition including detection of the occurrence of the stack state by the first sensor 11 is satisfied, the controller 13 at least resets the pieces of information stored in the storage section 144. In this embodiment, the reset condition may include not only detection of the occurrence of the stack state by the first sensor 11 but also various types of conditions (e.g., continuation of the stack state over the stand-by time) determined by the preliminary process.

(4) Variation

The first embodiment is an example of various embodiments of the present disclosure. Various modifications may be made to the first embodiment depending on design and the like as long as the object of the present disclosure is achieved. Moreover, a function similar to the shopping basket 1 may be realized by a control method of a carrier, a computer program, or a storage medium in which a program is recorded, or the like. A control method of a carrier according to one aspect is a control method of a carrier (shopping basket 1) and includes resetting pieces of information stored in a storage section 144 when a reset condition including detection of occurrence of a stack state by a first sensor 11 (stack sensor) is satisfied. The carrier mentioned in the variation includes a body 10, the storage section 144, and the first sensor 11. The body 10 is configured to hold a transportation object (an item of goods 91). The storage section 144 is configured to store information. The first sensor 11 is configured to detect the occurrence of the stack state where the body 10 and a detection target (a power supply apparatus 2 or another shopping basket 1) are stacked relative to each other.

A control method of a carrier according to another aspect is a control method of a carrier (shopping basket 1) and includes switching an operation mode of an electric circuit 14 from a normal mode to a power saving mode when a first sensor 11 (stack sensor) detects occurrence of a stack state. The carrier mentioned herein includes a body 10, the electric circuit 14, and the first sensor 11. The body 10 is configured to hold a transportation object (an item of goods 91). The electric circuit 14 has at least two operation modes which are the normal mode and the power saving mode in which power consumption is less than in the normal mode. The first sensor 11 is configured to detect the occurrence of the stack state where the body and a detection target (a power supply apparatus or another shopping basket 1) are stacked relative to each other.

(4.1) First Variation

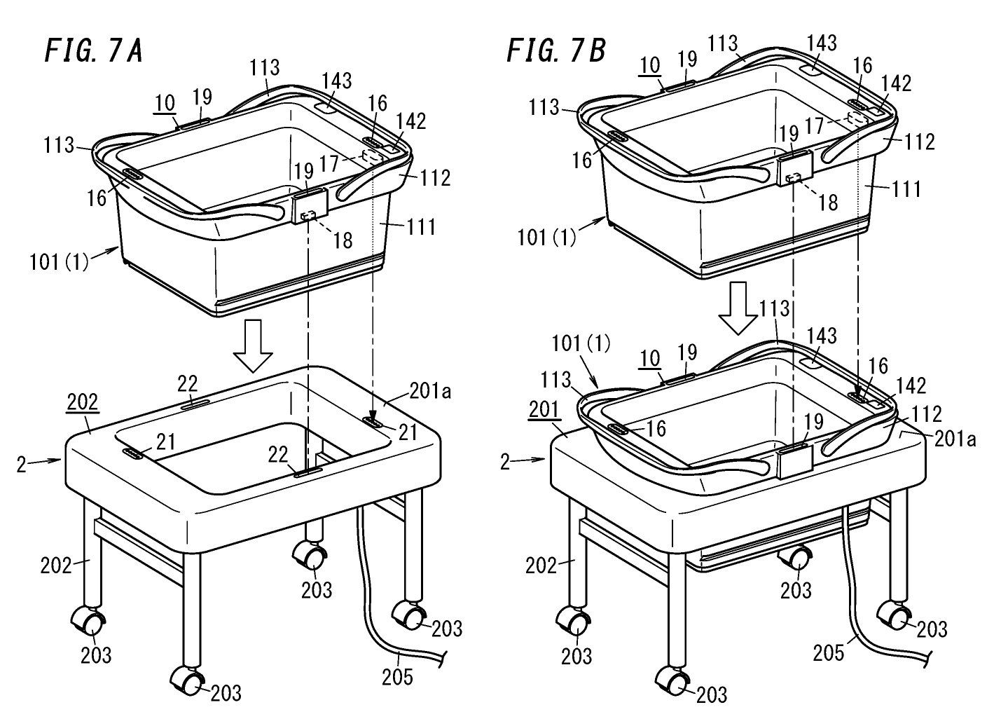

As illustrated in FIGS. 7A and 7B, a shopping basket 1 according to a first variation of the first embodiment further includes magnet sensors 18. In the shopping basket 1, a first sensor 11 detects in each case occurrence of a stack state in accordance with whether or not magnets 22 or 19 provided to a detection target (a power supply apparatus 2 or another shopping basket 1) is within a prescribed range from the magnet sensors 18 provided to a body 10.

In the example shown in FIGS. 7A and 7B, two magnets 22 are provided on an upper surface 201a of a frame body 201. The two magnets 22 are disposed at locations around an opening in the frame body 201 so as to be point-symmetric with a center point of the opening as a point of symmetry. Similarly, two magnets 19 are provided on an upper surface of a flange 112 of the body 10. The two magnets 19 are provided at locations around an opening in the flange 112 so as to be point-symmetric with a center point of the opening as a point of symmetry.

The magnet sensors 18 are provided on a lower surface of the flange 112. More specifically, in a state where the body 10 of the shopping basket 1 is placed on another shopping basket 1 or the power supply apparatus 2 serving as an adjacent upper node, the magnet sensors 18 are disposed at locations to face the magnets 19 or 22 of the adjacent upper node (the another shopping basket 1 or the power supply apparatus 2).

According to the configuration of the first variation, the first sensor 11 detects occurrence of a stack state (first stack state) where the body 10 is stacked on the adjacent upper node (the another shopping basket 1 or the power supply apparatus 2). Note that, for example, the magnet sensors 18 may be disposed on the upper surface of the flange 112. In this configuration, the first sensor 11 can also detect occurrence of a stack state (second stack state) where an adjacent lower node (another shopping basket 1) is stacked on the body 10.

(4.2) Second Variation

A shopping basket 1 according to a second variation of the first embodiment switches states of pieces of information stored in a storage section 144 from a set state to a reset state to realize resetting of information.

Specifically, in the second variation, pieces of goods information are associated with flags on a one-to-one basis and are stored in the storage section 144, and the value of each flag is switched between “1” (set value) and “0” (reset value), thereby realizing a reset function of each piece of goods information. That is, switching the value of a flag corresponding to each piece of goods information from “1” to “0” realizes resetting of each piece of goods information without deleting it from the storage section 144.

Note that the configuration should not be construed as limiting, but, for example, two storage areas corresponding to the set state and the reset state may be set in the storage section 144, and depending on the storage area in which a piece of goods information is to be stored, switching between the set state and the reset state may be performed. That is, the controller 13 moves a piece of goods information in the storage area corresponding to the set state in the storage section 144 to the storage area corresponding to the reset state, thereby switching the state of the piece of goods information from the set state to the reset state.

In the second variation, even when a piece of goods information is reset, the piece of goods information is not deleted from the storage section 144, but, for example, the piece of goods information which has been reset can remain as a log. The piece of information remaining as a log in the storage section 144 can be transmitted to a store device 3 by, for example, a specific operation performed on the store device 3.

(4.3) Third Variation

A shopping basket 1 according to a third variation of the first embodiment has a function of acquiring customer information regarding a customer 92. As used herein, the term “customer information” is information regarding an individual customer 92 and includes at least customer identification information (customer ID) for identifying the customer. The shopping basket 1 may acquire the customer information from, for example, various types of cards such as member's cards, loyalty cards, or credit cards by using a card reader or may acquire the customer information by communication with a personal digital assistant of the customer 92, biometrics authentication (including facial recognition), or the like. Moreover, the shopping basket 1 may acquire the customer information from, for example, a magnetic code (e.g., a magnetic card), a barcode, or a two-dimensional code.

Based on the customer information, the shopping basket 1 can present to the customer 92 information such as recommendation information and advertisement suitable for the customer 92 by a display or an voice output. Moreover, the shopping basket 1 associates the customer information with goods information and stores the customer information in a storage section 144, which allows collection of data denoting a favorite and the like of the customer 92. The shopping basket 1 is used by unspecific customers 92, and therefore, similarly to the goods information, the customer information regarding each of the unspecific customers 92 is preferably reset accordingly by a reset process.

(4.4) Other Variation

Variations other than the first to third variations of the first embodiment are listed below.

The shopping basket 1 according to the present disclosure includes a computer system in, for example, the controller 13. The computer system includes a processor and memory as hardware as main components. The processor executes a program stored in the memory of the computer system, thereby realizing functions as the shopping basket 1 in the present disclosure. The program may be stored in the memory of the computer system in advance, may be provided over a telecommunications network, or may be provided as a recording medium such as a computer-system readable memory card, an optical disk, a hard disk drive, or the like storing the program. The processor of the computer system includes one or a plurality of electronic circuits including semiconductor integrated circuits (IC) or large-scale integrated circuits (LSI). The plurality of electronic circuits may be collected on one chip or may be distributed on a plurality of chips. The plurality of chips may be collected in one device or may be distributed in a plurality of devices.

Moreover, connection of the input terminal 17 of the shopping basket 1 and the output terminal 21 or 16 of the power supply apparatus 2 or another shopping basket 1 as an adjacent upper node may be realized as contactless connection by, for example, electromagnetic coupling or electrostatic capacitance coupling. For example, in the case of the contactless connection by the electromagnetic coupling, charging electric power is supplied from a power transmitting coil included in the output terminal 21 or 16 to the power receiving coil included in the input terminal 17 in a contactless manner. Moreover, when the connection of the input terminal 17 and the output terminal 21 or 16 is realized as contactless connection, communication between the input terminal 17 and the output terminal 21 or 16 is also preferably realized by optical wireless communication adopting light such as infrared radiation or visible radiation as a medium or wireless communication adopting radio wave as a medium.

The frame body 201 does not necessarily include the plurality of output terminals 21 of the power supply apparatus 2 but may include only one output terminal 21. Alternatively, a plurality of output terminals 16 of the shopping basket 1 may be provided to one body 10 similarly to the output terminal 21 of the power supply apparatus 2. The plurality of output terminals 16 are disposed at locations around the opening in the flange 112 so as to be point-symmetric with a center portion of the opening as a point of symmetry. In this way, it is possible to connect the input terminal 17 to the output terminal 16 regardless of the orientation in which the plurality of shopping baskets 1 are stacked. Moreover, similarly to the output terminal 16, a plurality of input terminals 17 of the shopping basket 1 may be provided to one body 10. The plurality of input terminals 17 are disposed at locations around the opening in the flange 112 so as to be point-symmetric with a center point of the opening as a point of symmetry. In this way, it is possible to connect the input terminal 17 to the output terminal 16 regardless of the orientation in which th plurality of shopping baskets 1 are stacked. That is, the shopping basket 1 may adopt four types of configurations, namely, a configuration including one output terminal 16 and one input terminal 17, a configuration including a plurality of output terminals 16 and one input terminal 17, a configuration including one output terminal 16 and a plurality of input terminals 17, and a configuration of a plurality of output terminals 16 and a plurality of input terminals 17.

Moreover, when a plurality of output terminals 21 or 16 are provided to the power supply apparatus 2 or the shopping basket 1, all the plurality of output terminals 21 or 16 may be activated. Alternatively, of the plurality of output terminals 21 or 16, only the output terminal 21 or 16 to which the input terminal 17 is connected may be activated. When only the output terminal 21 or 16 to which the input terminal 17 is connected is activated, the power supply apparatus 2 or the shopping basket 1 includes a selector configured to select the output terminal 21 or 16 to be activated. In this case, the power supply apparatus 2 or the shopping basket 1 may detect the orientation of a shopping basket 1 as an adjacent lower node by a magnet sensor or the like to determine the output terminal 21 or 16 to be activated.

Moreover, the carrier is not limited to the shopping basket 1 but may be, for example, a container, such as a basket or a tableware, used in applications other than shopping, or a cart, a tray, a dish, a hand truck, or the like that holds a transportation object by mounting the transportation object thereon.

Moreover, the secondary battery 15 is not limited to a lithium ion battery, but for example, various types of secondary battery such as a nickel-hydrogen battery may be adopted. Moreover, the power supply of the shopping basket 1 is not limited to the secondary battery 15, but an appropriate power supply such as a primary battery or a photovoltaic cell may be adopted. Additionally or alternatively to the power supply such as the secondary battery 15, the primary battery, or the photovoltaic cell, the shopping basket 1 may include a power reception device. The power reception device is a device configured to receive electric power in a non-contact manner or in a wired manner from a power supply apparatus disposed outside the shopping basket 1, for example, a power supply apparatus installed on a floor or the like of a store.

Moreover, collection of the plurality of functions provided to the shopping basket 1 in one housing is not an essential configuration for the shopping basket 1, but components of the shopping basket 1 may be distributed in a plurality of housings. For example, the shopping basket 1 may be provided with the reading unit 141 separately from the body 10. Also in this case, a piece of goods information read by the reading unit 141 is transferred to the shopping basket 1 via, for example, the wireless section 147, and acquiring the piece of goods information in the shopping basket 1 is thus possible. Moreover, at least some of the functions of the shopping basket 1 may be realized by, for example, a server system or cloud (cloud computing).

Moreover, the electric circuit 14 may include the first sensor 11, the second sensor 12, the controller 13, and the like. In contrast, the reading unit 141, the display 142, the operation section 143 the charging circuit 146, and the like may be provided separately from the electric circuit 14.

Moreover, the shopping assistance system 5 may be used not only in a situation in which purchase of goods 91 is possible without operation by a clerk as illustrated in the case of the first embodiment but for example, also in a situation in which a clerk is at a checkout counter as in the case of a so-called manned checkout counter.

Moreover, the shopping assistance system 5 may further include a retrieval device configured to automatically retrieve a shopping basket 1 from the checkout space of the checkout counter. The retrieval device is configured to retrieve a shopping basket 1 which is empty in the checkout space to move it to the basket area. In this case, when discharge of goods 91 from the shopping basket 1 is completed, the retrieval device automatically retrieve (remove) the shopping basket 1 from the checkout space, and therefore, the customer 92 does not have to retrieve the shopping basket 1 by himself/herself.

Moreover, the flowchart shown in FIG. 5 is a mere example of an operation of the shopping basket 1, and for example, the order of the notification process (S3), the reset process (S4), the switching of operation mode (S5), and the like may be changed. Moreover, the notification processes (S3, S9) and the like may be accordingly omitted.

Moreover it is not an essential configuration for the shopping basket 1 that the electric circuit 14 stops supplying power to both the reading unit 141 and the display 142 in the first power saving mode and the second power saving mode. The electric circuit 14 may stop supplying power to one of the reading unit 141 and the display 142. Instead of the reading unit 141 and the display 142, or together with at least one of the reading unit 141 and the display 142 in the electric circuit 14, the electric circuit 14 may stop supplying power to sites other than the reading unit 141 and the display 142 in the electric circuit 14.

The variations described above is accordingly applicable in combination.

### Second Embodiment

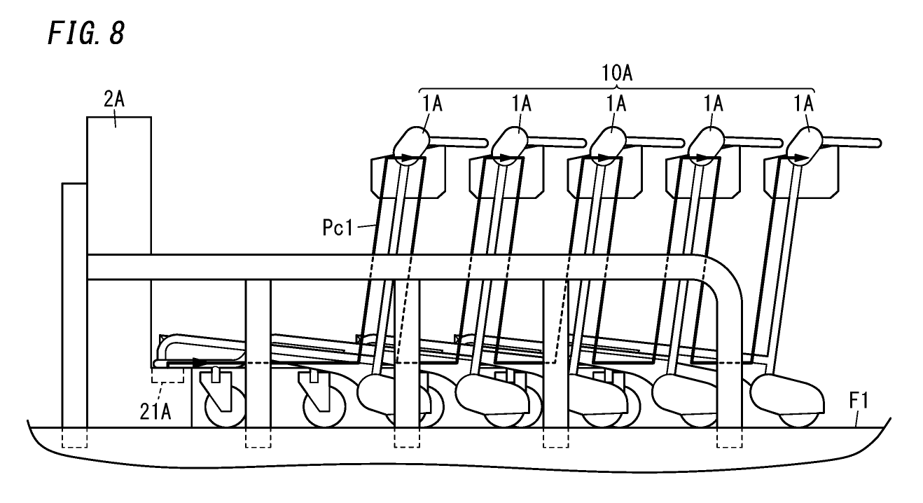

As illustrated in FIG. 8, a carrier according to the present embodiment is different from the carrier (shopping basket 1) according to first embodiment in that each of a plurality of carriers included in a standby group 100A is a cart 1A. In the following description, components similar to those in the first embodiment are denoted by the same reference signs as those in the first embodiment, and the description thereof is omitted.

That is, in the present embodiment, the carrier is, for example, a shopping cart used in a retail store or a transportation cart used in a facility such as an airport. The cart 1A includes: a stack sensor 11 (see FIG. 1); a controller 13 (see FIG. 1); an electric circuit 14 (see FIG. 1) including, for example, a display and a communication module; and a secondary battery 15 (see FIG. 1) serving as a power supply for operation of the electric circuit 14. The cart 1A is movable on a floor surface F1. A power supply apparatus 2A and the plurality of carts 1A are daisy chained to each other for a supply path of at least charging electric power with the power supply apparatus 2A as an uppermost node.

A direction in which the plurality of carts 1A are stacked is a lateral direction (horizontal direction) along the floor surface F1 but not the vertical direction (gravity direction). That is, the plurality of carts 1A are stacked along the horizontal direction. Similarly to the shopping baskets 1, the carts 1A stacked in a row are handled on a last-in first-out (LIFO) basis. In the example shown in FIG. 8, the plurality of carts 1A are sequentially stacked from left. Therefore, after a cart 1A is used, the cart 1A is returned to the right end of the standby group 100A, and when used, a cart 1A at the right end of the standby group 100A is taken. In the state in FIG. 8, charging electric power Pc1 is supplied to the plurality of carts 1A from an output terminal 21A of the power supply apparatus 2A.

The configuration described in the second embodiment is applicable accordingly in combination with the configuration (including variations) described in the first embodiment.

(Summary)

As described above, a carrier (shopping basket 1 or cart 1A) according to a first aspect includes a body (10), a storage section (144), a stack sensor (first sensor 11), and a controller (13). The body (10) is configured to hold a transportation object (a least an item of goods 91). The storage section (144) is configured to store information. The stack sensor is configured to detect occurrence of a stack state where the body (10) and a detection target are stacked relative to each other. The controller (13) is configured to reset the information stored in the storage section (144) when a reset condition including detection of the occurrence of the stack state by the stack sensor is satisfied.

With this aspect, in the stack state where the carrier and the detection target are stacked relative to each other, the information stored in the storage section (144) is automatically reset. Thus, while the carrier is unused, that is, while the carrier is not used to transport the transportation object, the information stored in the storage section (144) may be reset. Thus, even when unspecific users (customers 92) use the carrier, it is possible to reduce cases where the shopping basket 1 with remaining information regarding a previous user (customer 92) is used by a next user (customer 92).

In a carrier (shopping basket 1 or cart 1A) according to a second aspect referring to the first aspect, the detection target includes another carrier (shopping basket 1) configured to hold the transportation object.

With this aspect, stacking the carriers enables the information stored in the storage section (144) to be reset.

A carrier (shopping basket 1 or cart 1A) according to a third aspect referring to the first or second aspect further includes a secondary battery (15) configured to be charged with charging electric power supplied from a power supply apparatus (2). The detection target includes the power supply apparatus (2).

With this aspect, relatively stacking the carrier and the power supply apparatus (2) with each other for the purpose of, for example, charging of the secondary battery (15) enables the information stored in the storage section (144) to be reset.

In a carrier (shopping basket 1 or cart 1A) according to a fourth aspect referring to any one of the first to third aspects, the stack sensor is configured to detect a presence or absence of the stack state with reference to a presence or absence of an electrical connection between a connection terminal and a counter terminal. The connection terminal (a contact 161 or 171) is provided to the body (10). The counter terminal (an output terminal 16 or 21 or an input terminal 17) is provided to the detection target.

With this aspect, the occurrence of the stack state is detected by detecting the presence or absence of the electrical connection, and therefore, wrong detection of the occurrence of the stack state can be reduced.

In a carrier (shopping basket 1 or cart 1A) according to a fifth aspect referring to any one of the first to fourth aspects, the stack state includes a first stack state and a second stack state. The first stack state is a state where the body (10) is stacked on the detection target. The second stack state is a state where the detection target is stacked on the body (10). The controller (13) is configured to determine that the occurrence of the stack state is detected by the stack sensor when the stack sensor detects either the first stack state or the second stack state.

This aspect enables the information stored in the storage section (144) to be reset as long as the stack state is achieved regardless of whether the body (10) is stacked on the detection target or the detection target is stacked on the body (10).

A carrier (shopping basket 1 or cart 1A) according to a sixth aspect referring to any one of the first to fifth aspects further includes an electric circuit (14). The electric circuit (14) has at least two operation modes which are a normal mode and a power saving mode in which power consumption is less than in the normal mode. The controller (13) is configured to switch the operation mode of the electric circuit (14) from the normal mode to the power saving mode when the stack sensor detects the occurrence of the stack state.

With this aspect, in the stack state where the carrier and the detection target are stacked relative to each other, the operation mode of the electric circuit (14) is automatically switched to the power saving mode. Thus, while the carrier is unused, that is, the carrier is not used to transport the transportation object, it is possible to reduce power consumption by the electric circuit (14) of the carrier, and it is possible to reduce unnecessary power consumption by the electric circuit (14).

A carrier (shopping basket 1 or cart 1A) according to a seventh aspect referring to the sixth aspect further includes a secondary battery (15) and a charging circuit (146) configured to charge the secondary battery (15). The charging circuit (146) is configured to charge the secondary battery (15) at least when the operation mode of the electric circuit (14) is the power saving mode.

With this aspect, the secondary battery (15) can be charged with the carrier and the power supply apparatus (2) being stacked relative to each other.

In a carrier (shopping basket 1 or cart 1A) according to an eighth aspect referring to the sixth or seventh aspect, the controller (13) is configured to switch the operation mode of the electric circuit (14) from the power saving mode to the normal mode when the stack sensor no longer detects the stack state.

With this aspect, when the stack state where the carrier and the detection target are stacked relative to each other is released, the operation mode of the electric circuit (14) is automatically switched to the normal mode. This allows a customer (92) or the like who use the carrier to omit a labor of switching the operation mode from the power saving mode to the normal mode in use of the carrier.

A carrier (shopping basket 1 or cart 1A) according to a ninth aspect referring to any one of the sixth to eighth aspects further includes a second sensor (12) configured to detect occurrence of an event which is prescribed. The second sensor (12) is different from a first sensor (11) which is the stack sensor. The operation mode of the electric circuit (14) further has a second power saving mode in which power consumption is less than in the normal mode. The second power saving mode is different from a first power saving mode which is the power saving mode. The controller (13) is configured to switch the operation mode of the electric circuit (14) from the normal mode to the second power saving mode when the second sensor (12) detects the occurrence of the event.

With this aspect, it is possible to switch the operation mode of the electric circuit (14) to the (second) power saving mode also in a state other than the stack state.

In a carrier (shopping basket 1 or cart 1A) according to a tenth aspect referring to the ninth aspect, the event is that a movement state of the body (10) satisfies a prescribed determination condition.

With this aspect, for example, when the body (10) is in a still state, the operation mode of the electric circuit (14) can be switched to the second power saving mode.

In a carrier (shopping basket 1 or cart 1A) according to an eleventh aspect referring to any one of the sixth to tenth aspects, the transportation object is an item of goods (91). The electric circuit (14) includes a reading unit (141) configured to read goods information on the item of goods (91). The electric circuit (14) is configured to stop supplying power to the reading unit (141) in the power saving mode.

With this aspect, stopping supplying power to the reading unit (141) which consumes a relatively large amount of power can reduce power consumption by the electric circuit (14) of the carrier, and it is possible to reduce unnecessary power consumption by the electric circuit (14).

A carrier (shopping basket 1 or cart 1A) according to a twelfth aspect referring to any one of the first to fifth aspects further includes a second sensor (12) and an electric circuit (14). The second sensor (12) is configured to detect occurrence of an event which is prescribed. The second sensor (12) is different from a first sensor (11) which is the stack sensor. The electric circuit (14) has at least two operation modes which are a normal mode and a power saving mode (including a first power saving mode and a second power saving mode) in which power consumption is less than in the normal mode. The controller (13) is configured to reset the information and switch the operation mode of the electric circuit (14) from the normal mode to (the first power saving mode of) the power saving mode when the reset condition is satisfied. The controller (13) is configured to forgo resetting the information and switch the operation mode of the electric circuit (14) from the normal mode to (the second power saving mode of) the power saving mode when the second sensor (12) detects the occurrence of the event.

With this aspect, of stack states, in a stacked state where the carrier and the detection target are stacked relative to each other, the operation mode of the electric circuit (14) is automatically switched to the power saving mode. Thus, while the carrier is unused, that is, the carrier is not used to transport the transportation object, it is possible to reduce power consumption by the electric circuit (14) of the carrier, and it is possible to reduce unnecessary power consumption by the electric circuit (14). Moreover, in states except for the stack state, it is possible to set the operation mode of the electric circuit (14) to the power saving mode without resetting the information stored in the storage section (144).

In a carrier (shopping basket 1 or cart 1A) according to a thirteenth aspect referring to the twelfth aspect, the event is that a movement state of the body (10) satisfies a prescribed determination condition.

With this aspect, for example, when the body (10) is in a still state or the like, it is possible to set the operation mode of the electric circuit (14) to the power saving mode.

In a carrier (shopping basket 1 or cart 1A) according to a fourteenth aspect referring to any one of the first to thirteenth aspects, the reset condition includes continuation of the stack state over a stand-by time.

With this aspect, even when the stack sensor detects the occurrence of the stack state, the information stored in the storage section (144) is not reset unless the stack state continues over the stand-by time. Thus, it is possible to reduce cases where the information stored in the storage section (144) is reset, for example, in a case where the stack sensor wrongly detects the occurrence of the stack state temporarily.

In a carrier (shopping basket 1 or cart 1A) according to a fifteenth aspect referring to any one of the first to fourteenth aspects, the reset condition includes that the transportation object is not held by the body (10).

With this aspect, even when the stack sensor detects the occurrence of the stack state, the information stored in the storage section (144) is not reset as long as the transportation object is held by the body (10). Thus, for example, it is possible to reduce cases where the information stored in the storage section (144) is reset when the stack sensor wrongly detects occurrence of the stacked state with the transportation object being held by the body (10).

In a carrier (shopping basket 1 or cart 1A) according to a sixteenth aspect referring to any one of the first to fifteenth aspects, the controller (13) is configured to perform a preliminary process before resetting the information after the reset condition is satisfied, and the preliminary process varies depending on whether or not the information stored in the storage section (144) has been output.

With this aspect, for example, it is possible to take a measure such as notifying a user (customer 92) of a message in the preliminary process when the information stored in the storage section (144) has not been output.

In a carrier (shopping basket 1 or cart 1A) according to an seventeenth aspect referring to any one of the first to sixteenth aspects, the controller (13) is configured to switch a state of the information stored in the storage section (144) from a set state to a reset state to reset the information.

With this aspect, the information stored in the storage section (144) is not immediately deleted even when the information is reset, and therefore, for example, the information which has been reset can be left as a log.

In a carrier (shopping basket 1 or cart 1A) according to an eighteenth aspect referring to any one of the first to seventeenth aspects further includes a reading unit (141) configured to read goods information on an item of goods (91) which is the transportation object. The information stored in the storage section (144) includes the goods information. The controller (13) is configured to reset at least the goods information as the information.

With this aspect, when unspecific users (customers 92) use the carrier, it is possible to reduce cases where respective goods information on goods (91) which a previous user (customer 92) intended to purchase are wrongly used by a next user (customer 92).

A control method of a carrier (shopping basket 1 or cart 1A) according to a nineteenth aspect is a control method of a carrier including a body (10), a storage section (144), and a stack sensor. The control method includes resetting information stored in the storage section (144) when a reset condition including detection of occurrence of a stack state by the stack sensor is satisfied. The body (10) is configured to hold a transportation object. The storage section (144) is configured to store information. The stack sensor is configured to detect occurrence of a stack state where the body (10) and a detection target are stacked relative to each other.

With this aspect, in the stack state where the carrier and the detection target are stacked relative to each other, the information stored in the storage section (144) is automatically reset. Thus, while the carrier is unused, that is, while the carrier is not used to transport the transportation object, the information stored in the storage section (144) may be reset. Thus, even when unspecific users (customers 92) use the carrier, it is possible to reduce cases where the shopping basket 1 with remaining information regarding a previous user (customer 92) is used by a next user (customer 92).

In a control method of a carrier (shopping basket 1 or cart 1A) according to a twentieth aspect referring to the nineteenth aspect, the carrier further includes an electric circuit (14). The control method includes switching an operation mode of the electric circuit (14) from a normal mode to a power saving mode when the stack sensor detects the occurrence of the stack state. The electric circuit (14) has at least two operation modes which are the normal mode and the power saving mode in which power consumption is less than in the normal mode.

With this aspect, in a stack state where the carrier and a detection target are stacked relative to each other, the operation mode of the electric circuit (14) is automatically switched to the power saving mode. Thus, while the carrier is unused, that is, the carrier is not used to transport the transportation object, it is possible to reduce power consumption by the electric circuit (14) of the carrier, and it is possible to reduce unnecessary power consumption by the electric circuit (14).

The aspect should not be construed as limiting, but various configurations (including variations) of the carrier (shopping basket 1 or cart 1A) according to the first and second embodiments are realizable by a control method of a carrier, a computer program, or a storage medium in which a program is recorded, or the like.

The configurations according to the second to eighteenth aspects are not configurations essential for the carrier and may accordingly be omitted.

The configuration according to the twentieth aspect is not an essential configuration of the control method of the carrier and may be accordingly omitted.

A carrier (shopping basket 1 or cart 1A) according to a twenty-first aspect includes a body (10), an electric circuit (14), a stack sensor (first sensor 11) and a controller (13). The body (10) is configured to hold a transportation object (an item of goods 91). The electric circuit (14) has at least two operation modes which are a normal mode and a power saving mode in which power consumption is less than in the normal mode. The stack sensor is configured to detect occurrence of a stack state where the body (10) and a detection target are stacked relative to each other. The controller (13) is configured to switch the operation mode of the electric circuit (14) from the normal mode to the power saving mode when the stack sensor detects the occurrence of the stack state.

With this aspect, in the stack state where the carrier and the detection target are stacked relative to each other, the operation mode of the electric circuit (14) is automatically switched to the power saving mode. Thus, while the carrier is unused, that is, the carrier is not used to transport the transportation object, it is possible to reduce power consumption by the electric circuit (14) of the carrier, and it is possible to reduce unnecessary power consumption by the electric circuit (14).

A control method of a carrier (shopping basket 1 or cart 1A) according to a twenty-second aspect is a control method of a carrier includes a body (10), an electric circuit (14), and a stack sensor. The control method includes switching an operation mode of the electric circuit (14) from a normal mode to a power saving mode when the stack sensor detects occurrence of a stack state. The body (10) is configured to hold a transportation object. The electric circuit (14) has at least two operation modes which are the normal mode and the power saving mode in which power consumption is less than in the normal mode. The stack sensor is configured to detect the occurrence of the stack state where the body (10) and the detection target are stacked relative to each other.

With this aspect, in the stack state where the carrier and the detection target are stacked relative to each other, the operation mode of the electric circuit (14) is automatically switched to the power saving mode. Thus, while the carrier is unused, that is, the carrier is not used to transport the transportation object, it is possible to reduce power consumption by the electric circuit (14) of the carrier, and it is possible to reduce unnecessary power consumption by the electric circuit (14).

1. A carrier, comprising:
a body configured to hold a transportation object;
a storage section configured to store information;
a stack sensor configured to detect occurrence of a stack state where the body and a detection target are stacked relative to each other; and
a controller configured to reset the information stored in the storage section when a reset condition is satisfied, the reset condition including detection of the occurrence of the stack state by the stack sensor.

2. The carrier according to claim 1, wherein
the detection target includes another carrier configured to hold the transportation object.

3. The carrier according to claim 1, further comprising a secondary battery configured to be charged with charging electric power supplied from a power supply apparatus, wherein
the detection target includes the power supply apparatus.

4. The carrier according to claim 1, wherein
the stack sensor is configured to detect a presence or absence of the stack state with reference to a presence or absence of an electrical connection between a connection terminal provided to the body and a counter terminal provided to the detection target.

5. The carrier according to claim 1, wherein
the stack state includes a first stack state where the body is stacked on the detection target and a second stack state where the detection target is stacked on the body, and
the controller is configured to determine that the occurrence of the stack state is detected by the stack sensor when the stack sensor detects either the first stack state or the second stack state.

6. The carrier according to claim 1, further comprising an electric circuit having at least two operation modes which are a normal mode and a power saving mode in which power consumption is less than in the normal mode, wherein
the controller is configured to switch the operation mode of the electric circuit from the normal mode to the power saving mode when the stack sensor detects the occurrence of the stack state.

7. The carrier according to claim 6, further comprising:
a secondary battery; and
a charging circuit configured to charge the secondary battery, wherein
the charging circuit is configured to charge the secondary battery at least when the operation mode of the electric circuit is the power saving mode.

8. The carrier according to claim 6, wherein
the controller is configured to switch the operation mode of the electric circuit from the power saving mode to the normal mode when the stack sensor no longer detects of the stack state.

9. The carrier according to claim 6, further comprising a second sensor configured to detect occurrence of an event which is prescribed, the second sensor being different from a first sensor which is the stack sensor, wherein
the operation mode of the electric circuit further has a second power saving mode in which power consumption is less than in the normal mode, the second power saving mode being different from a first power saving mode which is the power saving mode, and
the controller is configured to switch the operation mode of the electric circuit from the normal mode to the second power saving mode when the second sensor detects the occurrence of the event.

10. The carrier according to claim 9, wherein
the event is that a movement state of the body satisfies a prescribed determination condition.

11. The carrier according to claim 6, wherein
the transportation object is an item of goods,
the electric circuit includes a reading unit configured to read goods information on the item of goods, and
the electric circuit is configured to stop supplying power to the reading unit in the power saving mode.

12. The carrier according to claim 1, further comprising:
a second sensor configured to detect occurrence of an event which is prescribed, the second sensor being different from a first sensor which is the stack sensor; and
an electric circuit having at least two operation modes which are a normal mode and a power saving mode in which power consumption is less than in the normal mode, wherein
the controller is configured to reset the information and switch the operation mode of the electric circuit from the normal mode to the power saving mode when the reset condition is satisfied, and
the controller is configured to forgo resetting the information and switch the operation mode of the electric circuit from the normal mode to the power saving mode when the second sensor detects the occurrence of the event.

13. A carrier according to claim 12, wherein
the event is that a movement state of the body satisfies a prescribed determination condition.

14. The carrier according to claim 1, wherein
the reset condition includes continuation of the stack state over a stand-by time.

15. The carrier according to claim 1, wherein
the reset condition includes that the transportation object is not held by the body.

16. The carrier according to claim 1, wherein
the controller is configured to perform a preliminary process before resetting the information after the reset condition is satisfied, the preliminary process varying depending on whether or not the information stored in the storage section has been output.

17. The carrier according to claim 1, wherein
the controller is configured to switch a state of the information stored in the storage section from a set state to a reset state to reset the information.

18. The carrier according to claim 1, further comprising a reading unit configured to read goods information on an item of goods which is the transportation object, wherein
the information stored in the storage includes the goods information, and
the controller is configured to reset at least the goods information as the information.

19. A control method of a carrier including
a body configured to hold a transportation object,
a storage section configured to store information, and
a stack sensor configured to detect occurrence of a stack state where the body and a detection target are stacked relative to each other,
the control method comprising:
resetting the information stored in the storage section when a reset condition is satisfied, the reset condition including detection of the occurrence of the stack state by the stack sensor.

20. The control method of the carrier according to claim 19, wherein
the carrier further includes an electric circuit having at least two operation modes which are a normal mode and a power saving mode in which power consumption is less than in the normal mode, and
the control method includes switching the operation mode of the electric circuit from the normal mode to the power saving mode when the occurrence of the stack state is detected by the stack sensor.
